(19) United States
(12) Patent Application Publication
(10) Pub. No.: US 2011/0109158 A1
(43) Pub. Date: May 12, 2011

(54) EXTRACTION, STORAGE AND DISTRIBUTION OF KINETIC ENERGY

(76) Inventor: Ian Olsen, Truckee, CA (US)

(21) Appl. No.: 12/835,606

(22) Filed: Jul. 13, 2010

Related U.S. Application Data
(60) Provisional application No. 61/225,103, filed on Jul. 13, 2009.

(51) Int. Cl. B60L 1/00; B60L 11/16; B60L 11/18; H02P 3/14

(52) U.S. Cl. 307/10.1; 180/65.31; 318/376

(57) ABSTRACT

An energy conversion system (ECS) is described for energy conversion and distribution including the conversion of vehicle-stored energy into electrical energy and the distribution of the electrical energy locally at the home or via a utility grid level. The ECS includes a system coupled or connected to a vehicle powertrain and comprising a storage cell, a control and monitoring device, a converter unit that converts direct current (DC) energy to alternating current (AC) energy (also referred to as a converter or as an inverter), and an electric generator which extracts kinetic energy created by a moving object or vehicle, converting it into electric energy. This energy is stored in discrete storage cells in the object or vehicle until it can be downloaded into an electrical distribution system or grid.

### RELATED APPLICATION

This application is related to U.S. patent application Ser. No. 61/225,103, filed Jul. 13, 2009.

### TECHNICAL FIELD

The following disclosure relates generally to energy conversion and distribution and, more particularly, to the conversion of vehicle-stored energy into electrical energy and the distribution of the electrical energy locally at the home or via a utility grid level.

### BACKGROUND

Moving objects create and store kinetic energy by the act of accelerating the object to a specific velocity and subsequently dissipate the kinetic energy through the act of slowing the object down. The kinetic energy can be put to use by transforming the kinetic energy into a commonly used form of energy having broad uses and capable of distribution.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a kinetic energy converter and storage system, under an embodiment.

FIG. 2 is a block diagram of a kinetic energy converter and storage system, under an embodiment.

FIG. 3 is a block diagram of a kinetic energy converter and storage system, under an alternative embodiment.

FIG. 4A is a block diagram of a kinetic energy converter and storage system, under another alternative embodiment.

FIG. 4B is a block diagram of a kinetic energy converter, storage system and plurality of generators, under another alternative embodiment.

FIG. 5A is a block diagram of a kinetic energy converter and storage system, under still another embodiment.

FIG. 5B is a block diagram of a kinetic energy converter, storage system, and plurality of generators, under another alternative embodiment.

FIG. 6 is a block diagram of the interface between the inverter/charging system and the system controller, under an embodiment.

FIG. 7 is the block diagram of the interface between the system controller and display system and the vehicle engine and/or transmission control unit, under an embodiment.

FIG. 8 is the block diagram of one embodiment of data system data points for the conversion and storage system, under an embodiment.

FIG. 9 is the block diagram of the vehicle conversion, storage, charging, inverter and grid interface, under an embodiment.

FIG. 10 is the block diagram of the conversion of vehicle kinetic energy by connection of the generator to the vehicle transmission, under an embodiment.

FIG. 11 is the block diagram of the conversion of vehicle kinetic energy by coupling or connection of the generator through integration into one or more of a vehicle wheel, tire, and axle assemblies, under an embodiment.

FIG. 12A is the block diagram of the conversion of vehicle kinetic energy by connection of the generator to the vehicle engine, under an embodiment.

FIG. 12B is the block diagram of the conversion of vehicle kinetic energy by connection of a plurality of generators to the vehicle, under an embodiment.

FIG. 13 is a diagram of two versions of integrated wheel generators for conversion of kinetic energy, under an embodiment.

FIG. 14 is a block diagram of a multiple-cell storage system for increased energy storage, under an embodiment.

FIG. 15 is a block diagram of the interface between the vehicle and the fixed energy distribution access point, under an embodiment.

FIG. 16A is a block diagram of the interface to a single user home socket or terminal block diagram, under an embodiment.

FIG. 16B is a block diagram of the interface to a single user energy distribution access point or terminal block diagram, under an embodiment.

FIG. 17 is a block diagram of the interface to a grid download terminal and the block diagram of the grid only download terminal, under an embodiment.

FIG. 18 is a block diagram of the interface to a grid download terminal which has a card, smart card, RFID (Radio Frequency Identification Tag), or similar interface to provide debit or credit transactions to either retail, corporate, government or utility entities, under an embodiment.

FIG. 19 is a block diagram of the interface to a grid download terminal which has a user interface terminal and can also provide transaction authentication via Cellular telephone, under an embodiment.

FIG. 20A is a schematic representation of four embodiments of download terminals, under an embodiment.

FIG. 20B is a block diagram of an energy distribution access point with local storage, under an embodiment.

FIG. 20C is a block diagram of an energy distribution access point without local storage, under an embodiment.

FIG. 20D is a block diagram of the interface of a energy distribution access point to both a vehicle which downloads energy and a vehicle that uploads energy, under an embodiment.

FIG. 20E is a block diagram of the interface to a multi-user download/upload energy distribution access point and terminal block diagram, under an embodiment.

FIG. 21 is a block diagram of the ECS system, under an embodiment.

FIG. 22A is a system mechanical schematic, under an embodiment.

FIG. 22B is a top view of the chassis, under an embodiment.

FIG. 23 is a side wall view of the chassis, under an embodiment.

FIG. 24 shows the chassis bus structure, under an embodiment.

FIG. 25 shows the connector spacing of the chassis, under an embodiment.

FIG. 26 is a table of the overall chassis dimensions, under an embodiment.

FIG. 27 is a table of the GTI dimensions, under an embodiment.

FIG. 28 is a mechanical interface between the chassis and storage cell, under an embodiment.

FIG. 29 shows the storage cell connection detail, under an embodiment.

FIG. 30 is a side view of the storage cell, under an embodiment.

FIG. 31 is a top view of the storage cell, under an embodiment.

FIG. 32 shows the storage cell mating slot, under an embodiment.

FIG. 33 is a table of battery enclosure dimensions, under an embodiment.

FIG. 34 is a table of the GTI specifications, under an embodiment.

FIG. 35 is a battery charging and discharging circuit, under an embodiment.

FIG. 36 is logic control circuitry of the battery charging and discharging circuit, under an embodiment.

FIG. 38 shows a charging cycle of the battery charging and discharging circuit, under an embodiment.

### DETAILED DESCRIPTION

Systems and methods are described below for energy conversion and distribution including the conversion of vehicle-stored energy into electrical energy and the distribution of the electrical energy locally at the home or via a utility grid level. The systems and methods of an embodiment include an energy conversion system (ECS). The ECS of an embodiment includes an apparatus or system coupled or connected to a vehicle powertrain and comprising a storage cell, a control and monitoring device, a converter unit that converts direct current (DC) energy to alternating current (AC) energy (also referred to as a converter or as an inverter), and an electric generator which extracts kinetic energy created by a moving object or vehicle, converting it into electric energy. This energy is then stored in discrete storage cells in the moving object until it can be downloaded into an electrical distribution system or grid.

In a vehicle, the term powertrain as used herein refers to the group of components that generate power and deliver it to the road surface, water, air, and/or any medium in which the host vehicle operates. These components include the engine, transmission, driveshaft, differential, and final drive components like drive wheels, tracks, propellers, and the like. The powertrain also includes components used to transform stored energy (e.g., chemical, solar, nuclear, kinetic, potential, etc.) into kinetic energy for propulsion purposes.

The ECS of an embodiment further comprises downloading terminals located in the home, business, and or public areas. The downloading terminals allow the stored energy to be downloaded one or more times a day to provide incremental electric generation which is subsequently consumed by traditional electric appliances or loads.

This system of kinetic energy conversion and distribution can be applied to any moving object and can supply electric energy through one of several conduits to power conventional and alternative electric appliances or distributed through an electrical distribution system.

In the following description, numerous specific details are introduced to provide a thorough understanding of, and enabling description for, embodiments of the ECS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The ECS of an embodiment includes three components, as described in detail below. The first component is the vehicular conversion of stored kinetic energy into stored electrical energy (energy converter). The second component is the conversion of the stored electrical energy in the vehicle into broadly usable line voltage electricity (energy translator). A third component of the system is the distribution and or transfer of the energy into an energy distribution access point (EDAP) or into the electric grid for multipoint distribution.

Conventional combustion engine vehicles rely on an alternator (electric generator) to provide electricity to ignite the fuel via spark/glow plugs as well as provide electric power to various electronic components, motors, displays, radio, etc. Energy to produce the electrical demand of the vehicle is provided by an alternator or generator connected to the motor. This generator produces electricity in the form of a modified Direct Current (DC). As the mass of the vehicle acts as a kinetic storage cell, extraction of this energy is done through use of the force of the mass in motion to drive one or more of a series of generators.

There are several conditions through which the kinetic forces can be extracted. The kinetic forces can be extracted by maintaining the velocity of the vehicle as it moves in a downhill direction. Here the accelerating mass of the vehicle creates additional energy. This energy is converted to electricity by inducing a load, for example, on the drive train of the vehicle through one or more generators as it is directed to charge the storage cell in the vehicle. This act transfers the kinetic energy and maintains the velocity of the vehicle at a predetermined rate.

The kinetic forces can also be extracted by reducing the velocity or decelerating a moving vehicle by using the loading of one or more generators to provide a braking force. The higher the demand for braking, the higher the load on the generator(s).

Furthermore, the kinetic forces can be extracted through conversion of the available output of the motor-attached generator while the vehicle is ideal or at a stop into electric energy and stored in the storage cell.

The kinetic forces can also be extracted by converting the lateral acceleration gain realized during turning of the vehicle into a controlled and balanced generation load. This potentially stabilizes the vehicle while simultaneously directing converted energy to the storage cells.

Generally, by placing a load on one or more generators through the act of charging an electric battery or storage cell, force is exerted against the moving mass of the vehicle. This force in turn reduces the stored kinetic energy. Kinetic energy which generally is dissipated through a variety of losses normal to the changing vehicle dynamics or the act of reducing the vehicles velocity is thus converted into electricity. The generator(s) therefore act separately or in unison to achieve the maximum conversion while not affecting the vehicles performance. More specifically a variable force can be applied to the vehicle to extract the energy normally lost as heat in the braking system, to charge the storage cells while the vehicle is decelerating, rolling downhill, or in steady state conditions such a idling or low load driving.

This variable load/charging action allows the energy to be extracted without affecting the fuel efficiency of the vehicle. It operates only when the energy has to be dissipated or when the motor is idle. The controller, through use of an algorithm, can maximize charging and vehicle performance. The generator(s) function in several roles. One it provides normal vehicle electric demand, it provides charging of the vehicles standard battery for starting, it provides charging of the secondary storage cell for use/distribution later, and as an artifact of charging the storage cell it can also provide additional vehicle braking functions.

The generator/alternator can be attached to the one of several locations in the vehicle, but is not limited to being attached to any particular location. For example, the generator/alternator can be attached to one or more of the following: the motor via a belt or chain driven attachment (normal with most vehicles); the transmission or drive line via a chain, belt, viscous coupling, or gear drive; individual wheels of the vehicle; the drive shaft or axle via, for example, an integrated generator on the shaft; individual wheels via, for example, stub axles with integrated generation; and braking system via, for example, an integrated rotor generator.

The kinetic energy conversion described herein can be applied to numerous types of moving equipment and vehicles. As described above, one or more generators can be attached to various locations on/in the vehicle depending on the design and function of the vehicle. Examples of using alternative vehicles follow.

The kinetic energy conversion can be used in rail cars or rolling stock. Rail cars, for example, use an energy converter and or translator attached to each rail car and one or more of its axles or wheels. The energy converter directs its kinetic energy from the rolling stock to the attached storage cell. The system controller determines when and how much energy is extracted, and monitors the velocity and acceleration of the rail cars. The energy converters can be coupled to function independently, act in a networked array between two or more rail cars, and/or function in a networked array with a central control function within the locomotive. Upon filling of the in vehicle storage cells, the individual rail cars energy payload can be transferred to either local storage or to the power grid directly through an EDAP. The transfer of energy can occur in singular serial fashion (individual rail cars), in bulk (two or more rail cars), and/or network parallel fashion (two or more rail cars with two or more connections) depending on the configuration of the EDAP.

The kinetic energy conversion can be used in locomotives. Under this embodiment, the energy converter is attached to the locomotive power source or drive train via an auxiliary shaft, belt, or gear drive. The energy converter is configures to extract kinetic energy from the locomotive during predetermined conditions where excess or available kinetic energy is at a level where extraction does not affect the performance of the locomotive. Similar to the rail cars described above, attachment of the energy converter can also be via the wheels and/or non powered axles on the locomotive.

The kinetic energy conversion can be used on light rail and powered rail transport systems where the energy converter is attached to the light rail power source or drive train via an auxiliary shaft, belt, or gear drive. In this embodiment, the energy converter extracts kinetic energy from the locomotive during predetermined conditions when excess or available kinetic energy is at a level where extraction does not affect the performance of the locomotive. Similar to the rail cars described above, attachment of the energy converter can also be via the wheels and/or non powered axles on the locomotive.

The kinetic energy conversion can be used on trucks and truck transport through attachment of the energy converter to either the trailer or tractor or combination of the two. In the case of attachment of the energy converter to only the trailer, one or more energy converters and or energy translator can be attached to the trailer and individual axles, one or more wheels, the brake system or any combination of these sources. The brake is either independent of the system or includes the generator as part of the brake system components. In an embodiment where the energy converter is attached to the truck or tractor, one or more energy converter(s) and or translator is attached to the truck power source or drive train via an auxiliary shaft, belt, or gear drive. Regardless of attached vehicle, the energy converter extracts kinetic energy from the truck during predetermined conditions where excess or available kinetic energy is at a level where extraction does not affect the performance of the truck. Like other vehicles, attachment can also be via other points throughout the truck such as wheels, brakes and driveline components.

The kinetic energy conversion can be used on buses and transport vans where the energy converter is attached for example to the buses power source or drive train via an auxiliary shaft, belt, or gear drive. The energy converter extracts kinetic energy from the bus during predetermined conditions, where excess or available kinetic energy is at a level where extraction does not affect the performance of the bus or transport van. Like other vehicles, attachment can also be via other points throughout the truck such as wheels, brakes and driveline components.

The kinetic energy conversion can be used on marine vehicles. For example, the converters can be used on powered boats and ships where the energy converters are attached for example to both the drive train via an auxiliary shaft, belt, or gear drive as well as the motor crankshaft. The energy converter extracts kinetic energy from the vehicle during predetermined conditions where excess or available kinetic energy is at a level where extraction does not affect the performance of the vehicle, when energy extraction can assist in the reduction in velocity, and/or where energy extraction can occur during idle conditions.

The kinetic energy conversion can be used on motorized equipment including but not limited to construction equipment, mobile street sign generator display systems, material handlers, cranes, conveyor systems, and tugs. Moreover, kinetic energy conversion can be used on airplanes via attachment of the energy converter to the turbine generator subsystem.

Once the converted energy reaches a predetermined level or becomes fully charged in the on-vehicle storage cell, energy utilization and therefore efficiency is maximized. The vehicle can then be connected to an energy distribution access point (EDAP). A device to convert the storage cell contents into a compatible electricity format is part of the system. The energy translator changes for instance the DC (direct current) electricity of the storage cell into AC (alternating current) electricity. Simultaneously, the converter matches voltage levels, frequency and phase to the access point ensuring compatibility. The power converter in conjunction with the system controller manage the storage cell discharge to maximize the cell life cycles as well as secondary effects such as heat generation which is an artifact of the charging, discharging, and conversion process. This converter also provides many other support functions such as electrical short detection, ground fault detection, surge suppression, etc.

Download to the EDAP supports both AC and DC transfers to allow higher download rates and higher efficiency through lower conversion losses.

The on-vehicle or off-vehicle AC/DC converter provides a common line voltage output to link to regional specific gird standards. The vehicle can then discharge the electric energy (download) into a single point home, business or multipoint regional grid offsetting the gross electric consumption. As each vehicular power generator downloads its payload the provider is credited with a commensurate energy credit or revenue. This is analogous to private energy providers who are compensated for each kilowatt hour they provide to the grid. As the availability of download sites increases, vehicles can deposit more energy to the grid per vehicle mile thus dramatically increasing the effective energy output of the fuel consumed.

Using the ECS of an embodiment, each vehicle using the ECS vehicle components becomes a micro power generator which is linked into the grid. As the number of vehicles increase the amount of energy consumption and production from a convention generation source is decreased. To capitalize on this it is contemplated that individuals and municipalities will put in place infrastructure to allow downloading of the vehicles stored energy in convenient locations which over time will become ubiquitous and available for quick discharge. This would enable a vehicle to download energy payloads multiple times a day.

The converter/translator and controller components of the system of an embodiment maximize the storage cell life by monitoring and controlling charge rates, storage cell temperature, and charge cycle depth. By fully utilizing the contents of the storage cell, great efficiencies in energy transformation, distribution and utilization are achieved in an embodiment. Sensors throughout the system allow the controller to monitor the critical parameters in the energy translator and the storage cells.

The system and the energy storage cell technology of an embodiment is agnostic of chemistry and battery technology and capitalizes on storage and cycle efficiency. The controller reads the storage cell type and functional parameters via a system interface that links all system components. In one embodiment, the interface is a differential mode serial data connection. The system adjusts the charge/discharge profile to optimize the upload and download processes. Vehicles can add incremental storage cells to balance kinetic energy conversion capacity and time to charge cell capacity. Each additional cell links itself with the system controller via the serial interface and also includes a mechanism to block discharge in case of damage. Storage cell capacity can be varied by altering the battery chemistry and physical dimensions.

Storage cells of an embodiment are configured for recycling. The cell configuration anticipates the recycling process by configuring the cell enclosures to facilitate the removal and reinstallation of new storage materials and chemistry. Thus the shell or enclosure is preserved and recycled. The individual storage cell chemistry is likewise configured to facilitate separation of core chemical materials and reprocessing. This dramatically reduces the chemical waste and improves reuse. Storage cell physical configuration is meant but not limited to support both the energy generation system and the EDAP.

The EDAP of an embodiment can be configured to support various applications while the basic configuration includes two modes of operation. The two modes of operation include a direct connection mode with a direct connection to the grid, and a remote control mode for remote control download connection to the grid. The EDAP also provides for one or more vehicles downloading at the same time.

Using the direct connection topology the EDAP provides a connection to download a payload directly into the grid. The download is managed via a system controller and a billing transaction subsystem which allows a user to input their personal account information so that energy entered into the grid can be metered and the value of the energy credited to the users account. Likewise the EDAP can operate in the reverse mode by providing electricity from the grid to an electric vehicle again managed by the system controller and billing transaction system. In the upload case the users account information is used to bill the user for the amount of energy they have used to charge their vehicle.

In the remote control mode with the remote control down load configuration of the EDAP, energy is downloaded as above, managed by the system controller and billing transaction subsystem. Instead of downloading the energy in an AC format as in the direct connection mode, the energy is transferred for example in a DC format from the vehicle to the EDAP where it is stored in storage cells inside the EDAP. Also contained in the remote download configuration is an energy translator or inverter. The translator and associated download control is managed by a third party via a communications network and can be initiated on demand. This provides a unique cellular generation model which allows for example a utility company to provide electric power on demand regionalized to the demand.

The EDAP of an embodiment comprises several components. The components comprise, but are not limited to, a connection to the electrical distribution system with a protection device such as circuit breaker, a controllable switch for connection and disconnection to the grid, an optional battery subsystem for local energy storage, and optional inverter for on demand download capability and AC/DC operation, a system controller to manage the EDAP system, a wired or wireless communication interface, and finally a billing transaction subsystem for the credit and debiting of energy uploads and downloads.

The EDAP of an embodiment can be configured to simultaneously support numerous vehicles. The storage cell and inverter capacity are scalable to optimize the EDAP based on volume of use, environment, cost and type of application. In the simplest configuration, for example, an EDAP has a socket or umbilical cord which provides a standard electric car connection and supports bidirectional operation as well as includes an adaptor for direct DC download. This EDAP connects directly to the electric power distribution network.

Following are additional examples of EDAP configurations. One example includes a single vehicle connection with local energy storage, energy upload and download capability and remote control connection to the electrical distribution network or grid. Another example includes a multi-vehicle connection with direct connection to the electrical distribution network and energy upload and download capability but without external control. A further example includes a multi-vehicle connection with local energy storage, energy upload and energy download capability, and remote control connection to the electrical distribution network or grid. An additional example includes a single or multiple vehicle connection with remote storage and energy upload and download capability and remote control connection to the electrical distribution network or grid. Yet another example of an embodiment includes a large scale vehicle connection such as a warehouse distribution center comprising subpanels connected to a high volume energy storage and inverter system with remote control connection to the electrical distribution network or grid. Moreover, an example includes a large scale vehicle connection such as a warehouse distribution center comprising subpanels connected to a high to the electrical distribution network or grid.

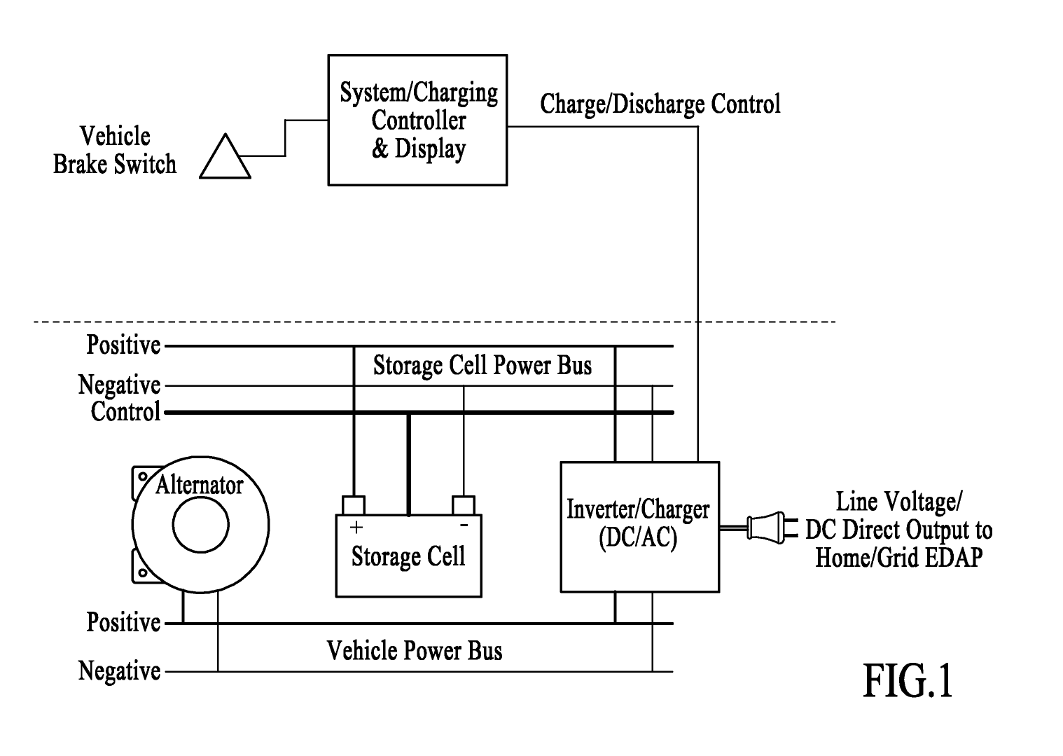

FIG. 1 is a block diagram of a kinetic energy converter and storage system, under an embodiment. The embodiment includes five components that comprise the vehicle kinetic energy conversion. The first component is the brake switch contact that indicates when the vehicle operator is attempting to reduce the kinetic energy. The second component is the system controller and display component which includes logic to control the charging of the storage cell(s), display of the system status, and monitor critical input signals and the discharging and inversion of the stored energy. The third component is the Inverter/Charging subsystem which both takes electric energy from the generator and charges the storage cell in a specific manner optimized for its chemistry. The Inverter/Charging subsystem also extracts energy from the storage cells and converts them into a format compatible with line voltage or electrical grid requirements (e.g., alternating current wave form with a potential of 110 volts). The fourth component is the storage cell which can be any device capable of storing electrical energy. The fifth component is the vehicle alternator or generator which produces electrical energy from mechanical. In this embodiment negative torque used to slow the vehicle is used to charge the storage cells. Options exist hereunder to use a motor generator to provide positive torque to help accelerate the vehicle and/or negative to decelerate it.

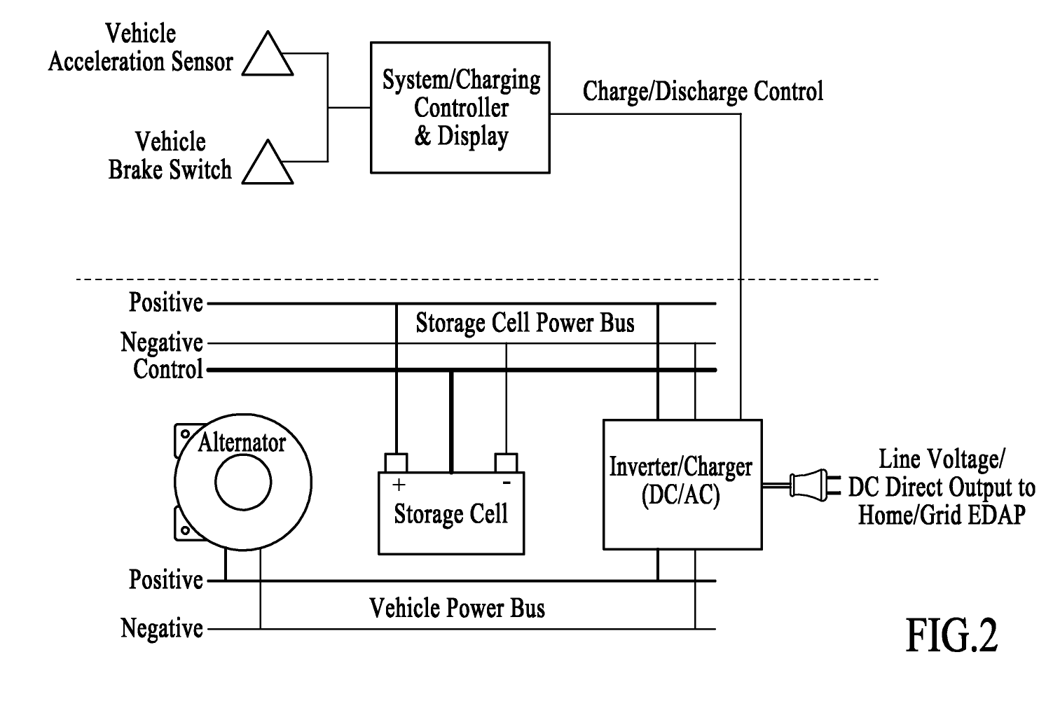

FIG. 2 is a block diagram of a kinetic energy converter and storage system, under an embodiment. This embodiment includes a vehicle accelerometer. The accelerometer determines the vehicle motion dynamics to better maximize the kinetic energy conversion, while simultaneously avoiding adversely effecting vehicle performance and fuel efficiency. The accelerometer can provide predictive analysis of when the driver is attempting to slow the vehicle and when the vehicle is running but at rest.

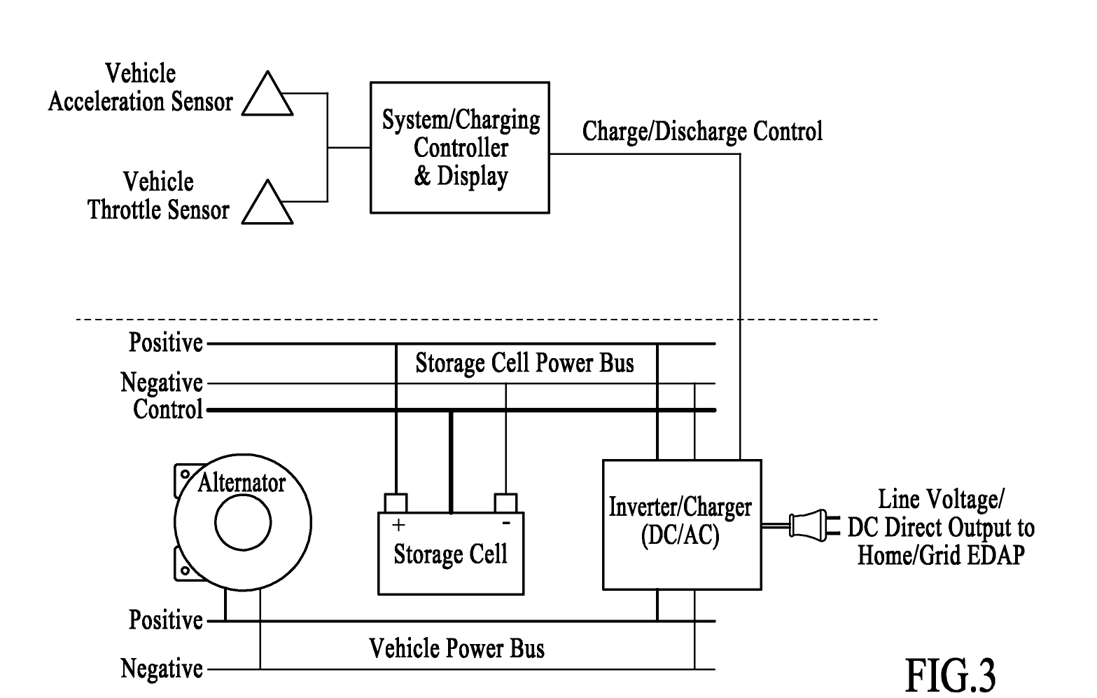

FIG. 3 is a block diagram of a kinetic energy converter and storage system, under an alternative embodiment. This embodiment replaces the brake switch with a vehicle throttle sensor providing a higher degree to predictive vehicle dynamics. Information or data of the throttle position and the acceleration allows the system controller to know for example when the vehicle is traveling down hill yet maintaining a constant velocity.

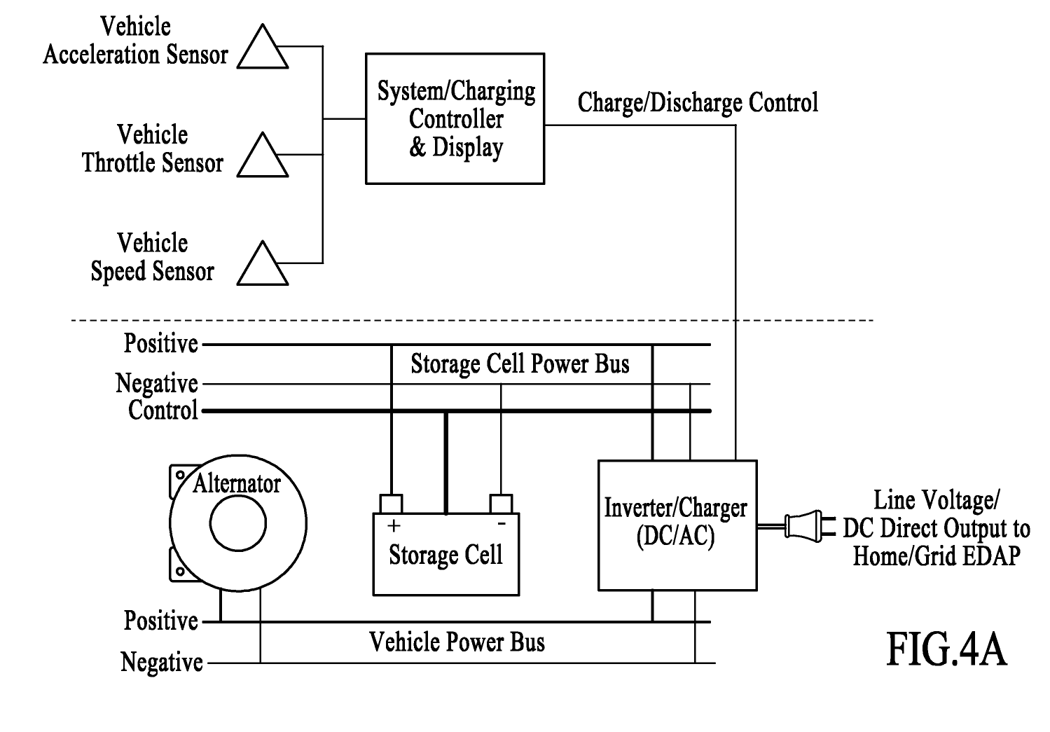

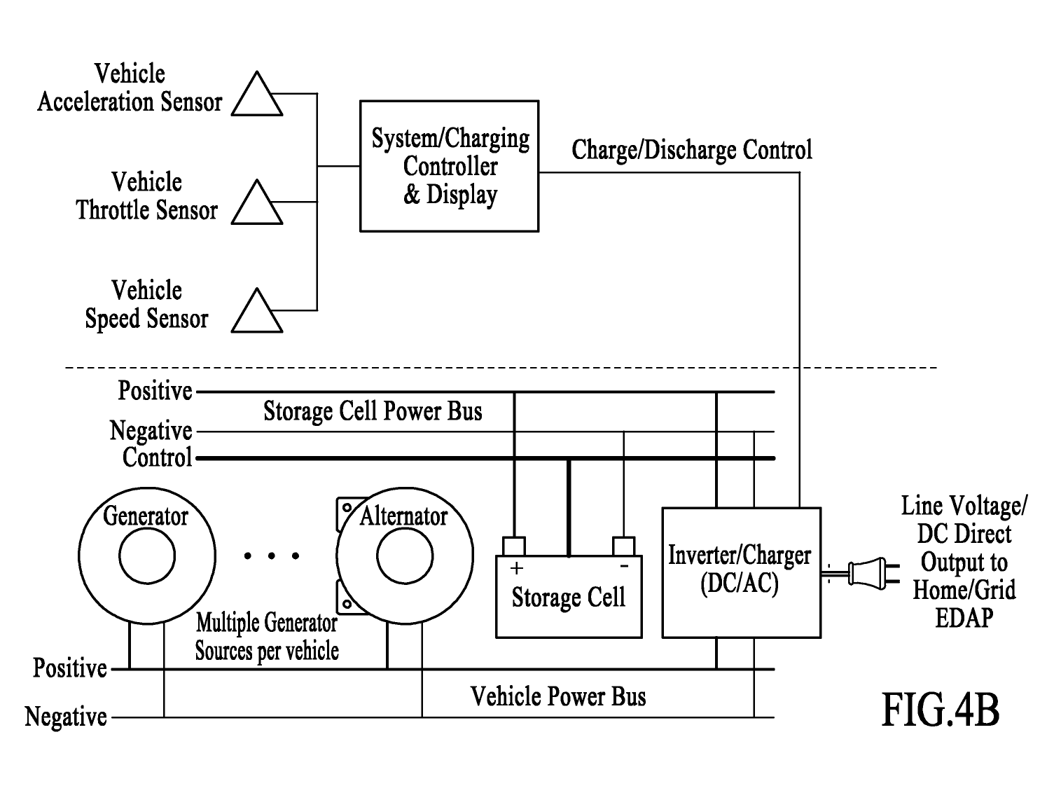

FIG. 4A is a block diagram of a kinetic energy converter and storage system, under another alternative embodiment. The control system of this embodiment adds a vehicle speed sensor to further improve predictive vehicle characteristic. The speed sensor allows the controller to for example know when the vehicle is at a high rate of speed and a constant velocity to take advantage of engine load to charge the storage cell.

FIG. 4B is a block diagram of a kinetic energy converter and storage system, under another alternative embodiment. The control system of this embodiment adds a generator and a vehicle speed sensor to further improve predictive vehicle characteristic. The speed sensor allows the controller to for example know when the vehicle is at a high rate of speed, in a turn, at a constant velocity, etc. to take advantage of a plurality of generation/conversion load points to extract kinetic energy. The combination of energy generation sources can optimize extraction to charge the storage cell and improve vehicle dynamics and stability.

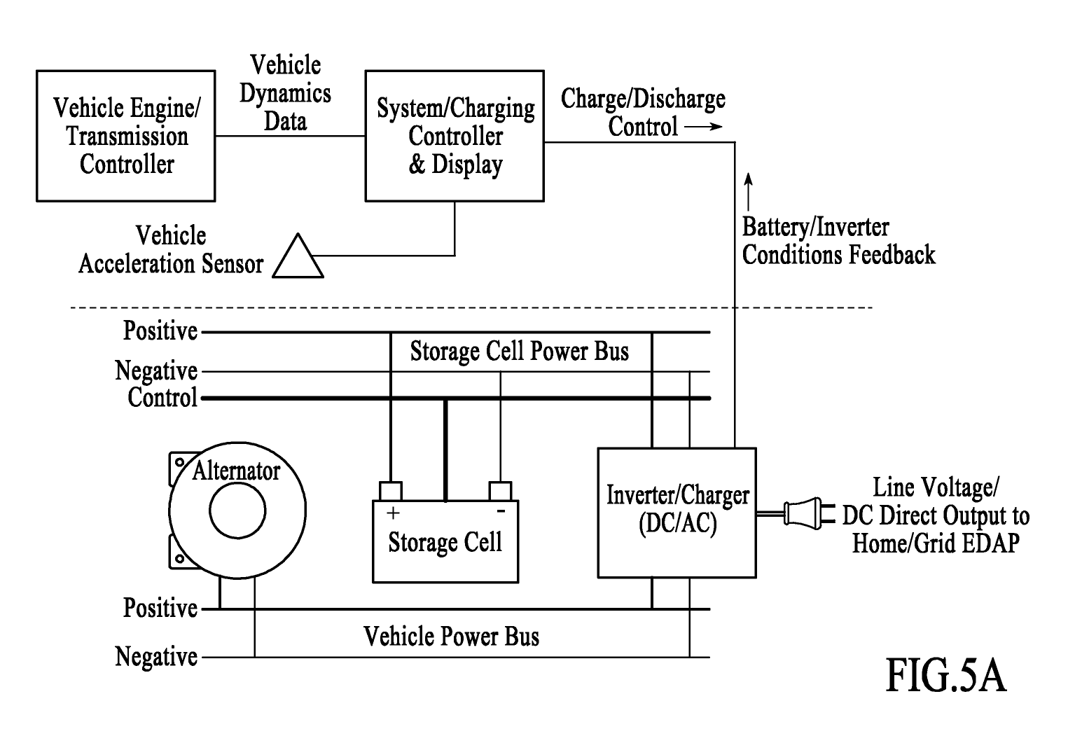

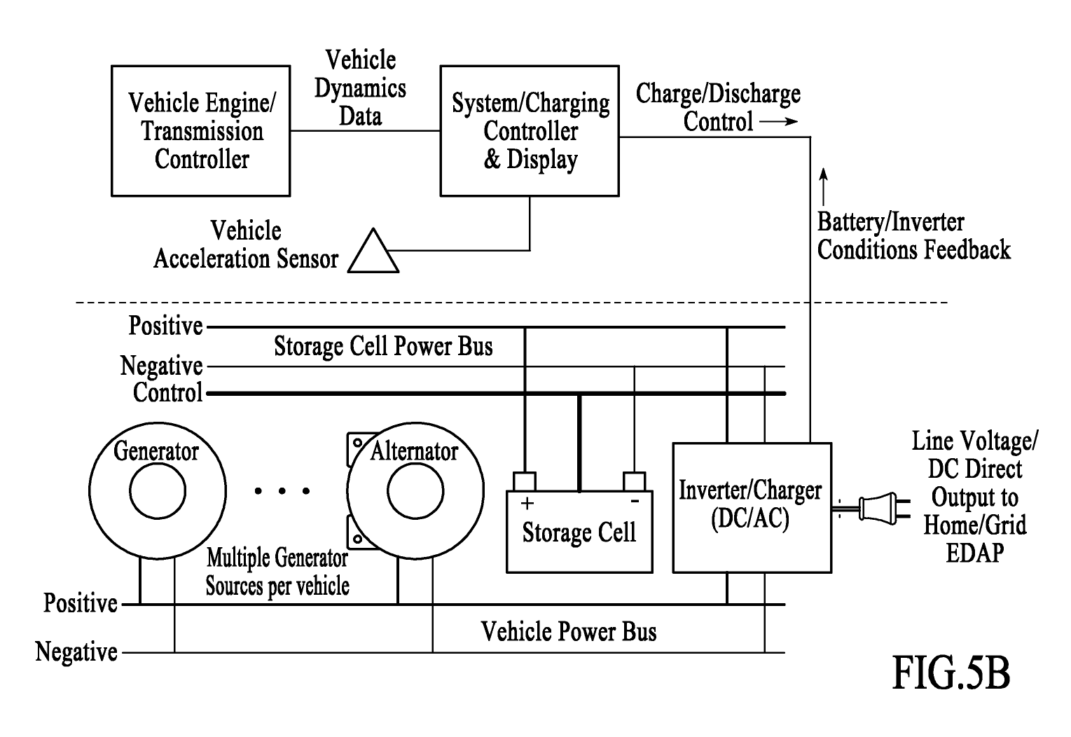

FIG. 5A is a block diagram of a kinetic energy converter and storage system, under still another embodiment. The ECS of this embodiment eliminates redundant vehicle sensors by coupling or connecting directly to the engine/transmission controller of the vehicle. All vehicle dynamics are then available to the system controller and can be used for determinative charging control. This provides optimized vehicle performance and energy conversion.

FIG. 5B is a block diagram of a kinetic energy converter and storage system, under still another embodiment. The ECS of this embodiment, which includes multiple energy generation sources, eliminates redundant vehicle sensors by coupling or connecting directly to the engine/transmission controller of the vehicle. All vehicle dynamics are then available to the system controller and can be used for determinative charging control to take advantage of a plurality of generation/conversion load points to extract kinetic energy. The combination of energy generation sources can optimize extraction to charge the storage cell and improve vehicle dynamics and stability.

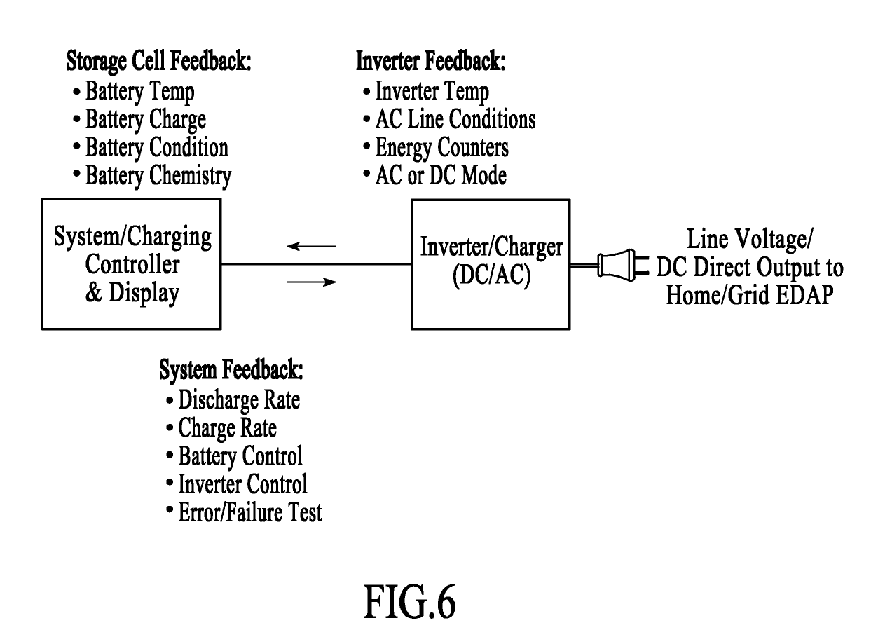

FIG. 6 is a block diagram of the interface between the inverter/charging system and the system controller, under an embodiment. The inputs to the controller show but are not limited to information about the storage cells and the inverter and charging subsystem. Conversely, control commands from the system controller are then fed back to the inverter/charging subsystem. They include but are not limited to those annotated in the figure.

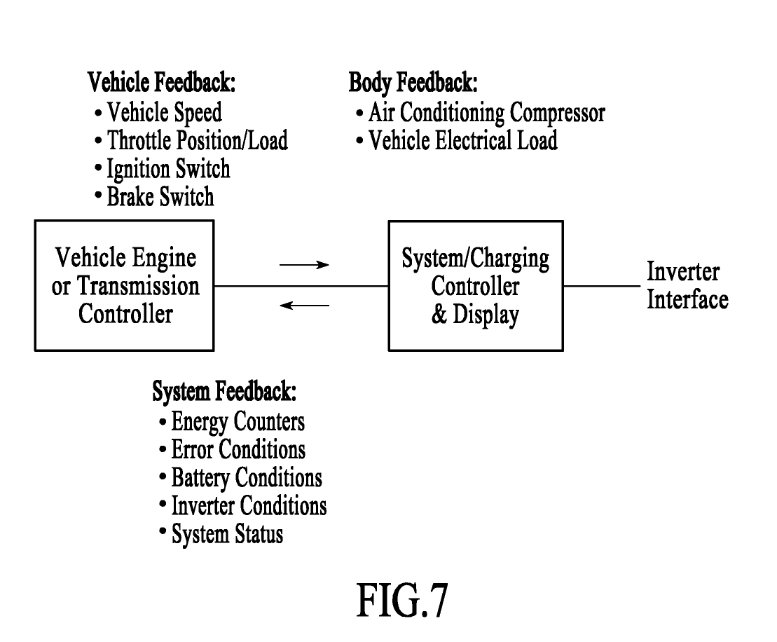

FIG. 7 is the block diagram of the interface between the system controller and display system and the vehicle engine and/or transmission control unit, under an embodiment. Inputs from the vehicle controller shown are not limited to those in the figure. Conversely, data requests and feedback to the vehicle engine/transmission controller shown are not limited to those in the figure.

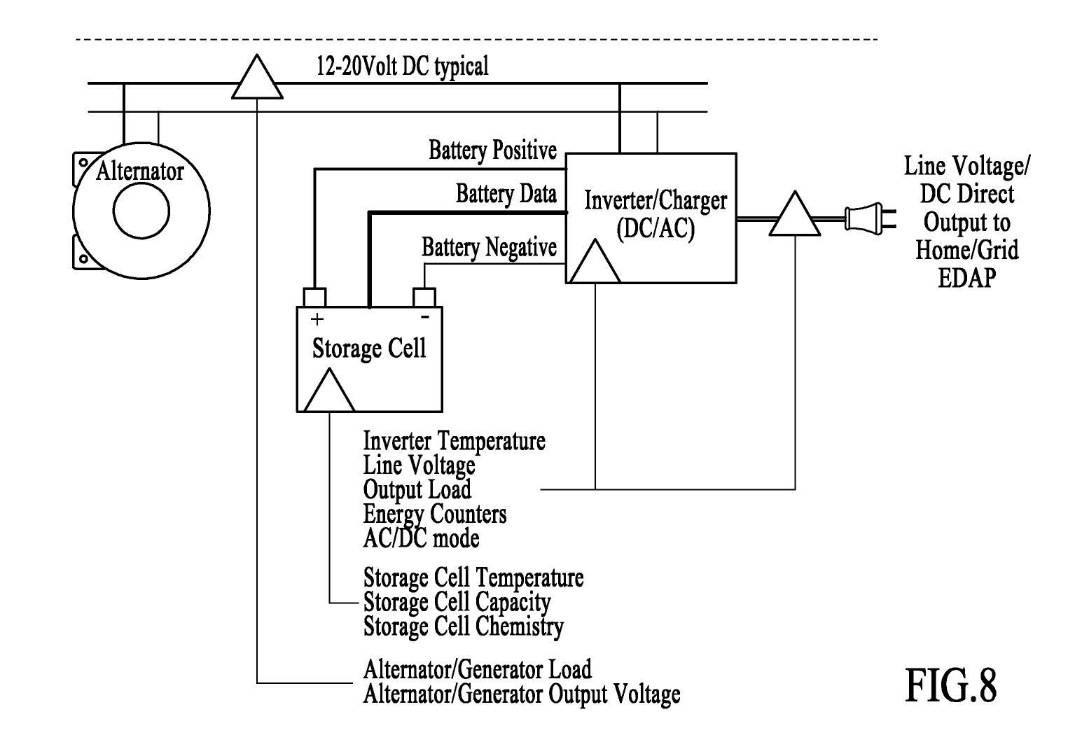

FIG. 8 is the block diagram of one embodiment of data system data points for the conversion and storage system, under an embodiment. This data system example shows some but not all the sensors or inputs which are used for the controller to maximize overall system performance.

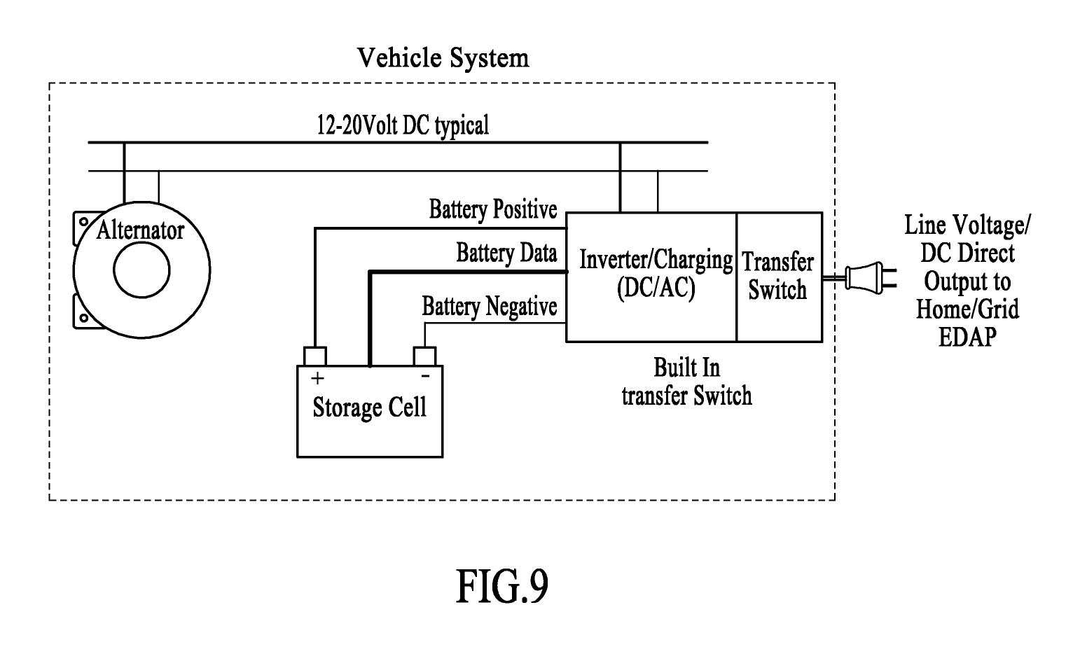

FIG. 9 is the block diagram of the vehicle conversion, storage, charging, inverter and grid interface, under an embodiment. This embodiment comprises a transfer switch built into the inverter/charging subsystem. This switch can be automatic or manual. The transfer switch allows the synchronized phase alignment of the inverter/charger to the home or national grid. The transfer switch also controls on/off function of the energy downloads.

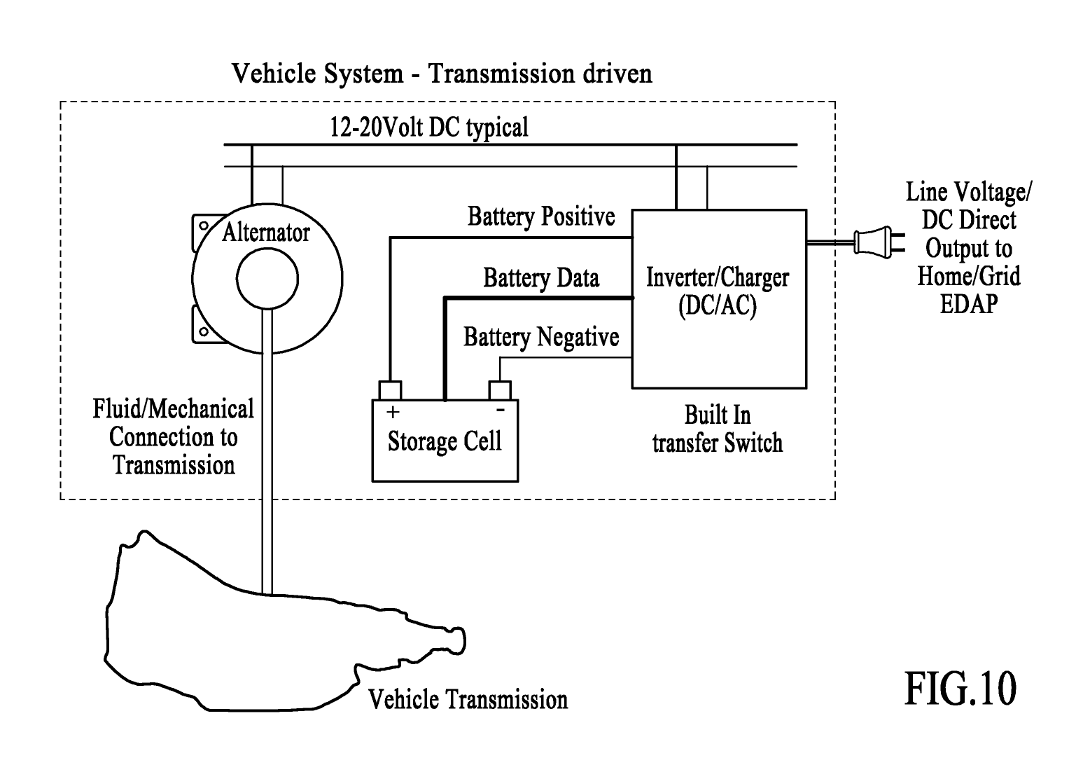

FIG. 10 is the block diagram of the conversion of vehicle kinetic energy by connection of the generator to the vehicle transmission, under an embodiment. This diagram shows a mode of operation in which the alternator/generator is driven by the transmission in the vehicle. Negative force can then be applied to the vehicle through the drive train. The physical connection between the generator and the transmission can be but is not limited to either mechanical for example gear driven or fluid driven for example an added impeller.

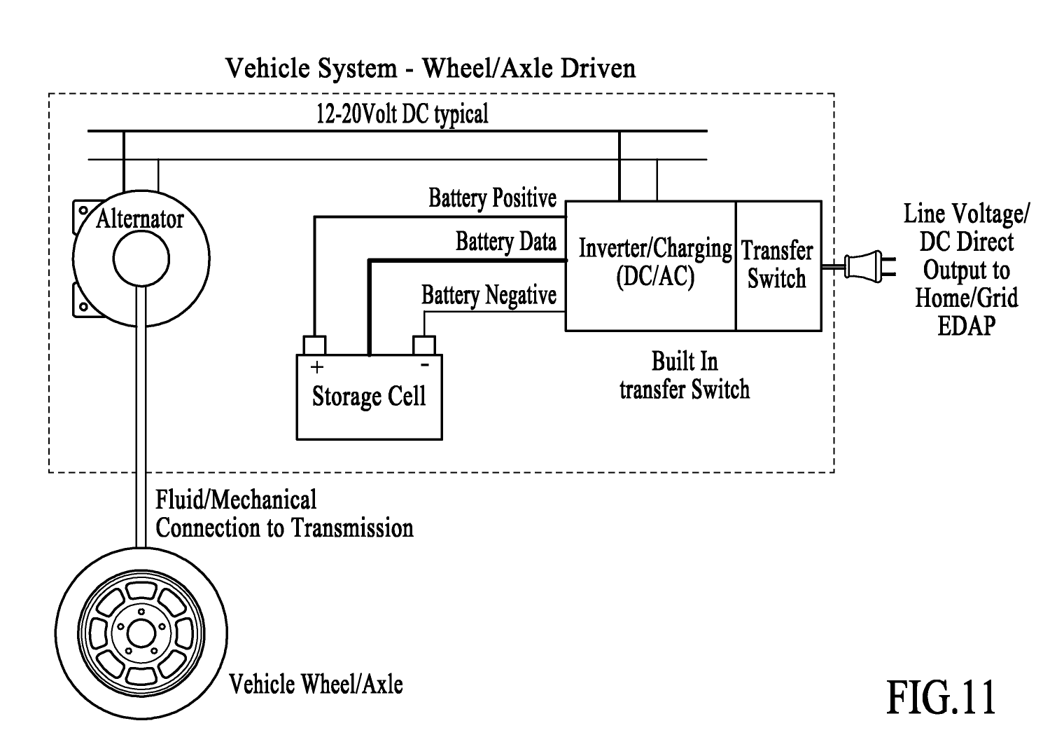

FIG. 11 is the block diagram of the conversion of vehicle kinetic energy by coupling or connection of the generator through integration into one or more of a vehicle wheel, tire, and axle assemblies, under an embodiment. This example shows a mode of operation in which a generator or plurality of generators is directly connected to one or more wheels of the vehicle. Negative force generated by initiating a charging cycle can then be applied to the vehicle through the wheels directly. The physical connection between the generator and the wheels can be but is not limited to the integration of the generator in the wheel directly.

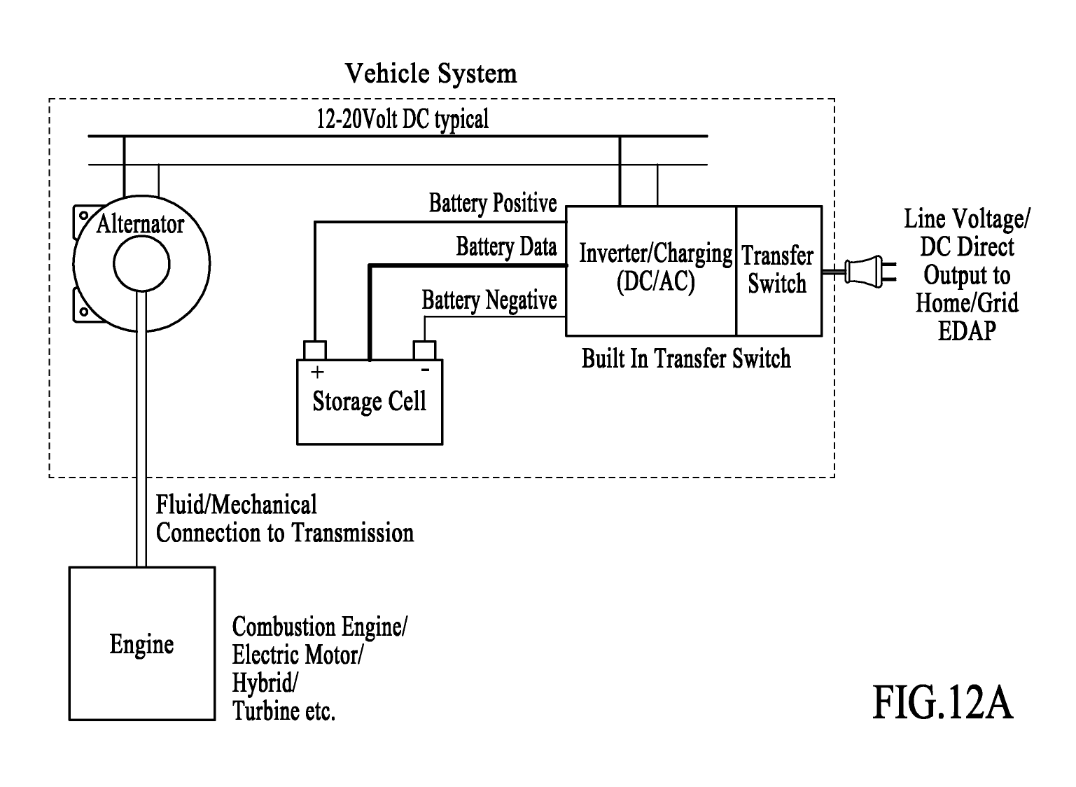

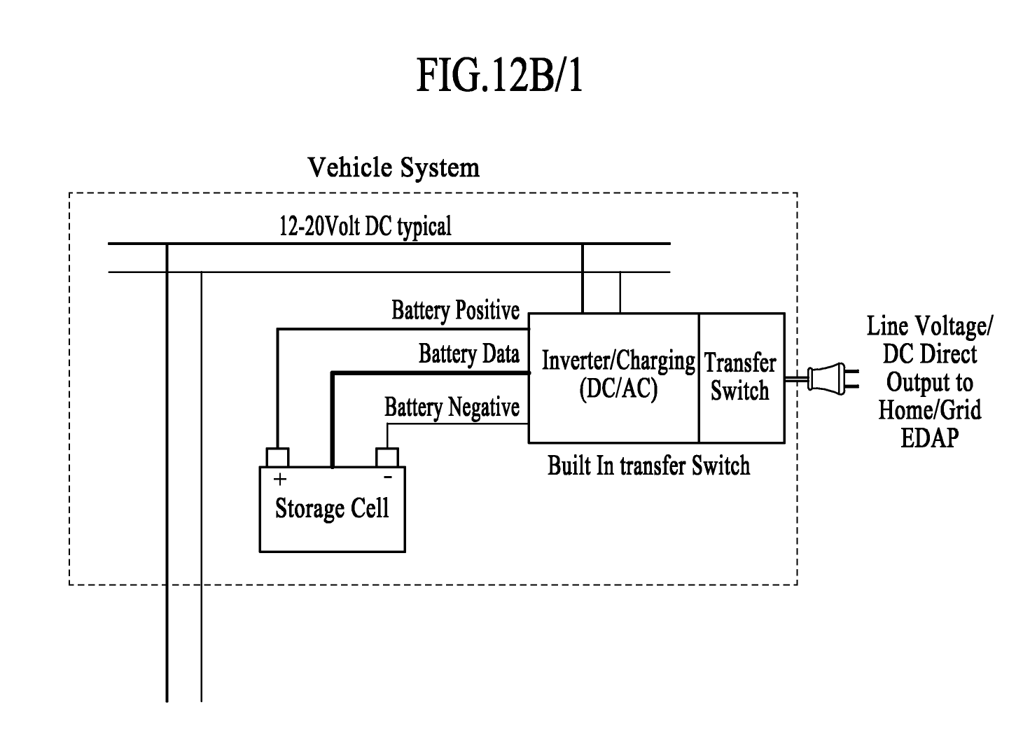

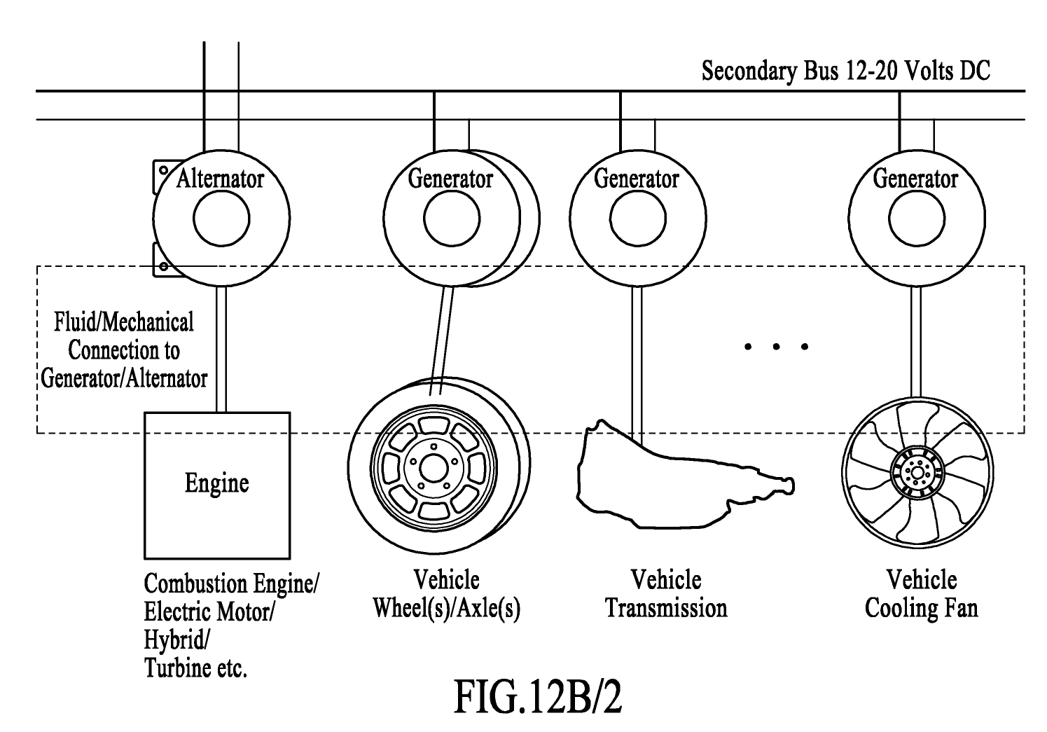

FIG. 12A is the block diagram of the conversion of vehicle kinetic energy by connection of the generator to the vehicle engine, under an embodiment. This diagram shows a mode of operation in which the alternator/generator is driven by the motor in the vehicle. Negative force generated by initiating a charging cycle can then be applied to the vehicle through the motor directly. The physical connection between the generator and the motor can be but is not limited to either a belt or chain driven connection.

FIG. 12B is the block diagram of the conversion of vehicle kinetic energy by connection of a plurality of generators or load points to the vehicle, under an embodiment. This diagram shows a mode of operation in which the alternator/generator is driven by multiple sources within the vehicle. Force generated by initiating a charging cycle in any one or more of the generation sources can then be applied to the vehicle thereby optimizing the vehicle dynamics and maximizing the energy conversion with a minimum effect on fuel performance. The physical connection between the generators and various points can be but is not limited to either a belt, gear, viscous coupling or chain driven connection.

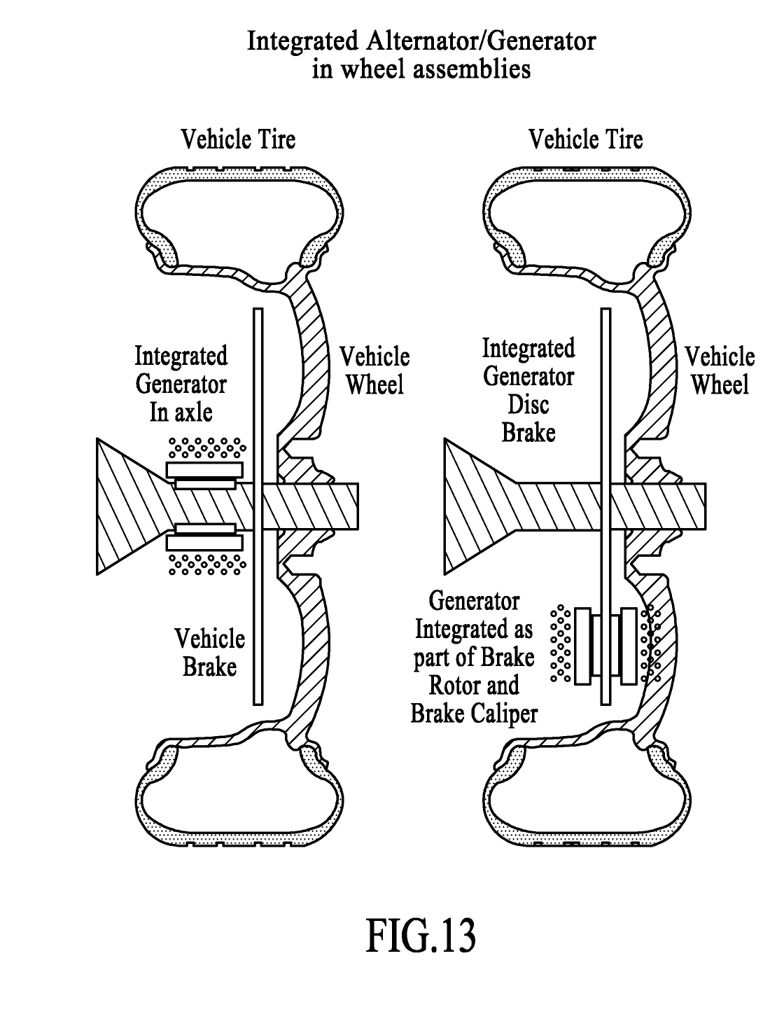

FIG. 13 is a diagram of the integrated wheel generators for conversion of kinetic energy, under an embodiment. This figure shows an example of how the generator can be integrated into one or more of the wheel stub axle assembly of a vehicle, one or more rotors, and/or one or more brake calipers.

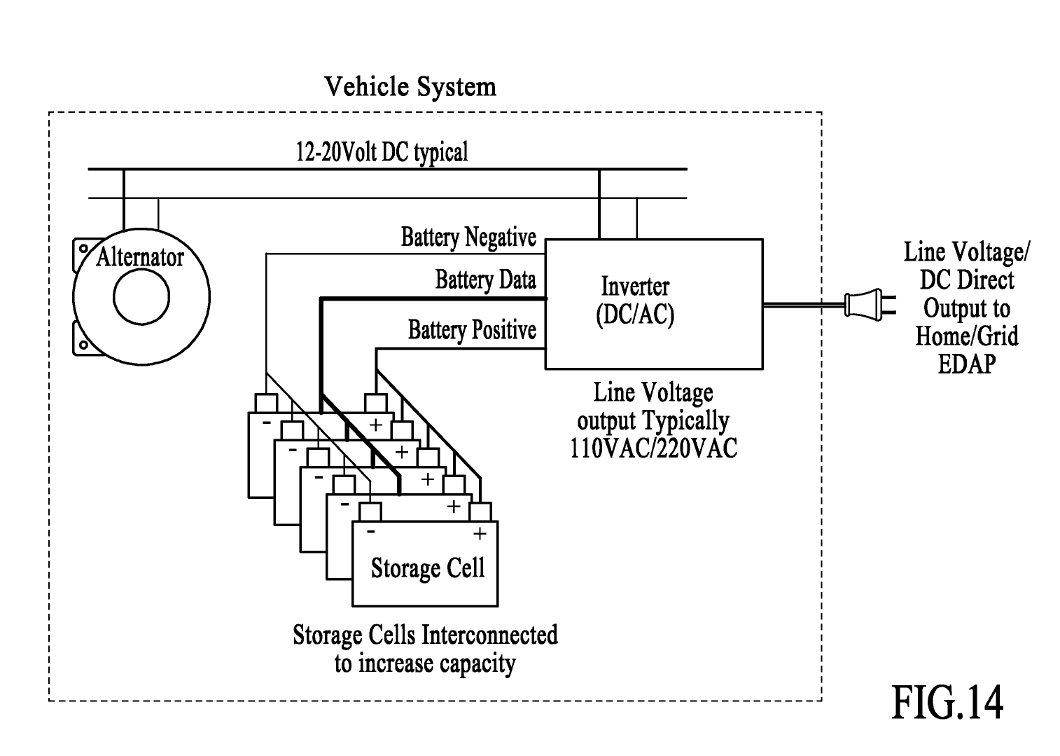

FIG. 14 is a block diagram of a multiple-cell storage system for increased energy storage, under an embodiment. In this embodiment, the system is expanded to provide more energy storage by increasing the number of storage cells. Cells in this example are discrete units which are daisy chained together. This mode also presumes controls to manage conditions where cells must be replaced and therefore should no longer be charged as well as conditions where the vehicle in case of accident can immediately lock cells from discharge.

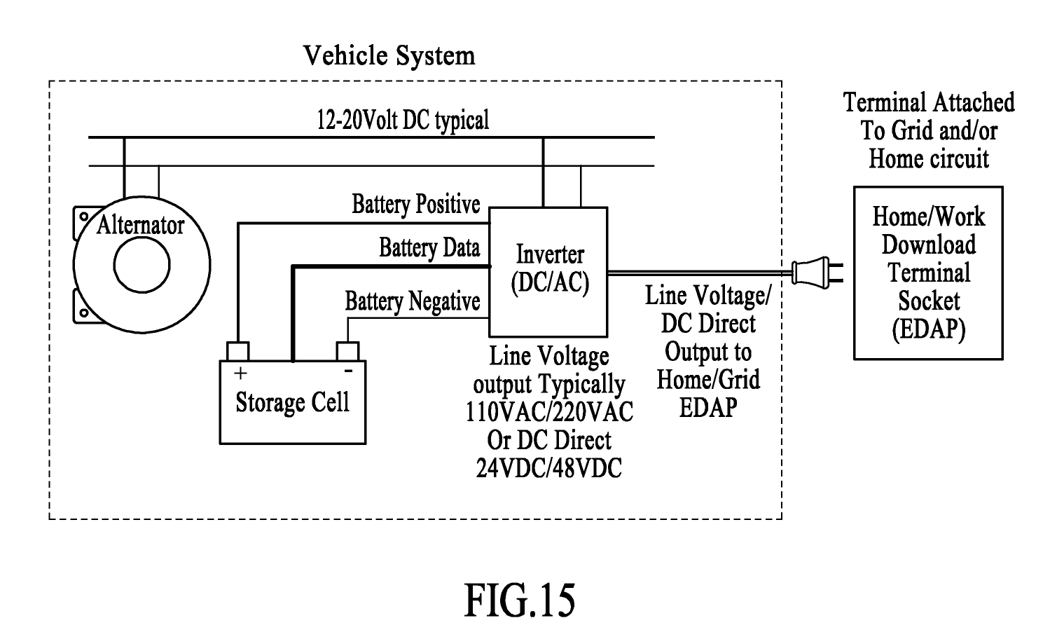

FIG. 15 is a block diagram of the interface between the vehicle and the fixed energy download terminal, under an embodiment. This example shows the interface for plugging the system into a remote download terminal. A download terminal can be located anywhere and, in an embodiment, a mode of operation involves coupling or connecting a conventional household extension cord between the plug on the car and the plug on the download terminal.

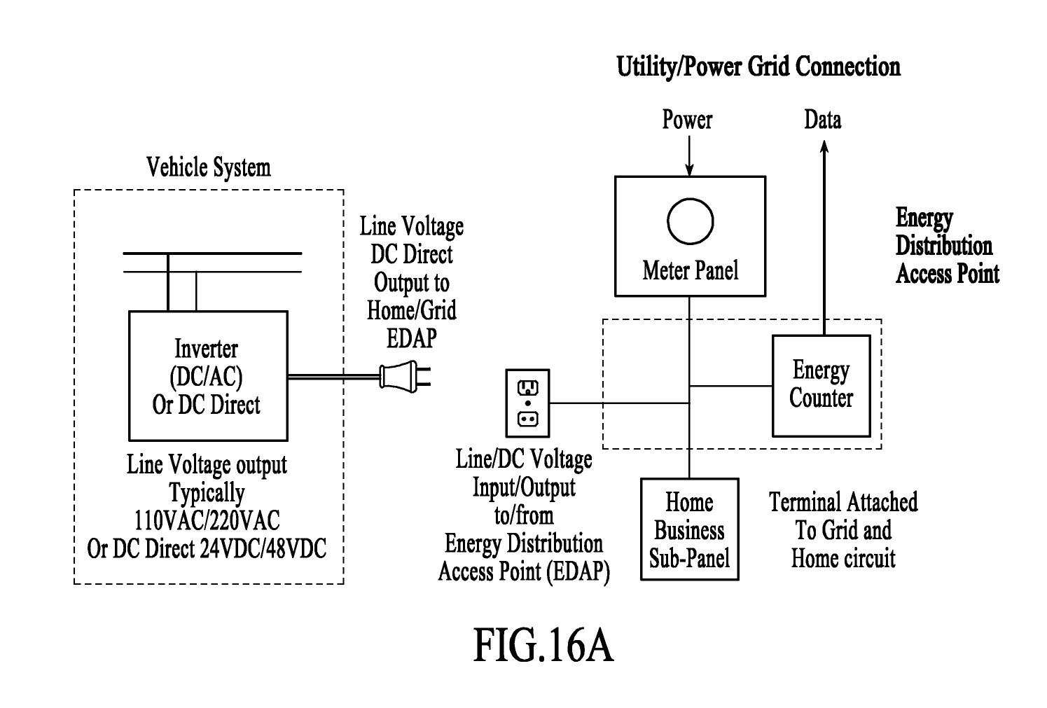

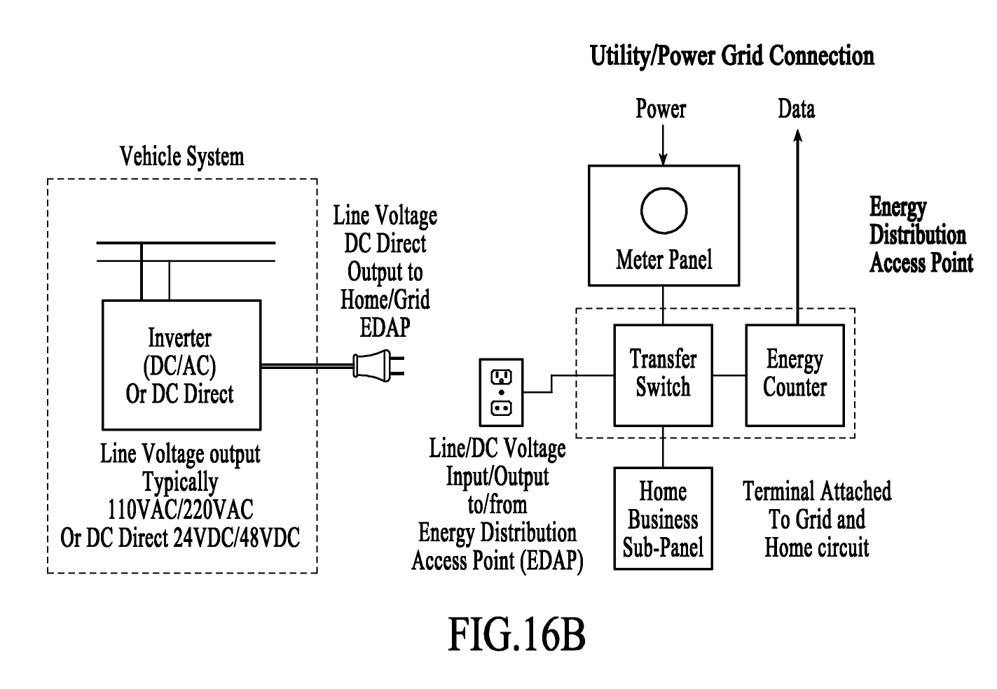

FIG. 16A is a block diagram of the interface to a single user download terminal and terminal block diagram, under an embodiment. The download terminal of an embodiment comprises five components or blocks. The first component is an input socket. The input socket of an embodiment is a household line voltage receptacle oriented for ease of use or for environmental considerations.

The second component of an embodiment is a bidirectional circuit breaker in the home or business subpanel. This provides short circuit and ground fault protection. The third component is the internal energy counter which provides exact energy (Watts) accumulation data and acts as a reporting conduit to process energy refunds and/or payments. The fourth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business.

FIG. 16B is a block diagram of the interface to a single user download terminal and terminal block diagram, under an embodiment. The download terminal of an embodiment comprises five components or blocks. The first component is an input socket. The input socket of an embodiment is a household line voltage receptacle oriented for ease of use or for environmental considerations. The second component is the transfer switch which provides one or more of the following functions: a physical isolation switch from the main power source to that of the vehicle; a synchronization function for the inverter to the grid frequency and phase; and a managed load modulator to balance the demand on the vehicle when the home or business load increases beyond the vehicles capacity.

The third component of an embodiment is a bidirectional circuit breaker in the home or business subpanel. This provides short circuit and ground fault protection. The fourth component is the internal energy counter which provides exact energy (Watts) accumulation data and acts as a reporting conduit to process energy refunds and/or payments. The fifth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business.

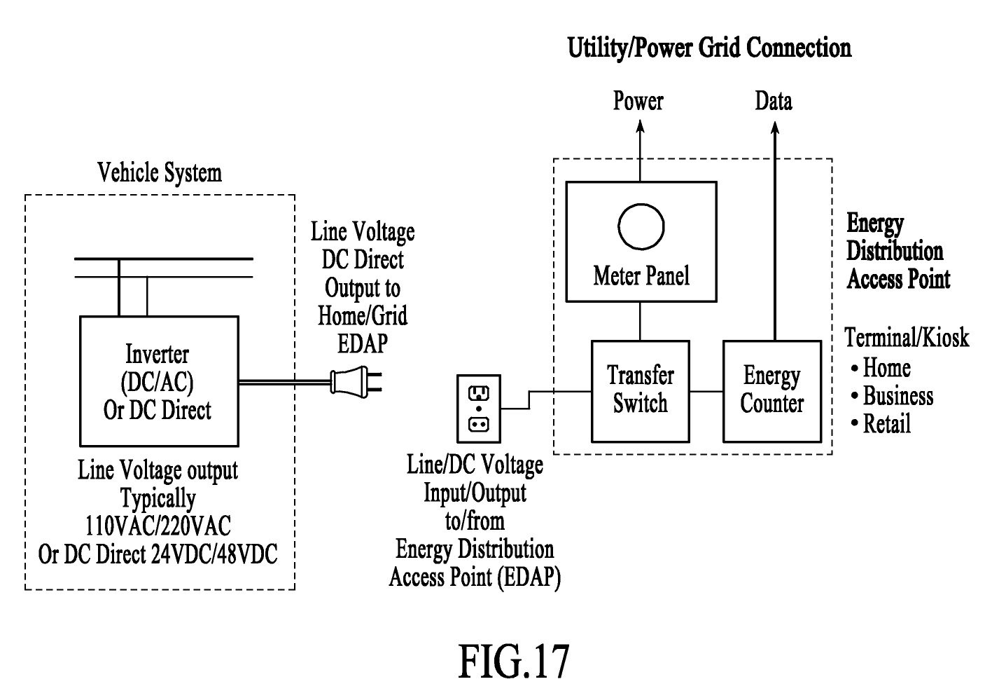

FIG. 17 is a block diagram of the interface to a grid download terminal and the block diagram of the grid only download terminal, under an embodiment. This embodiment includes a discrete kiosk configuration in which energy download is directed to the grid and not a home or business. In this mode no subpanel connection is required and the transfer switch is automatic.

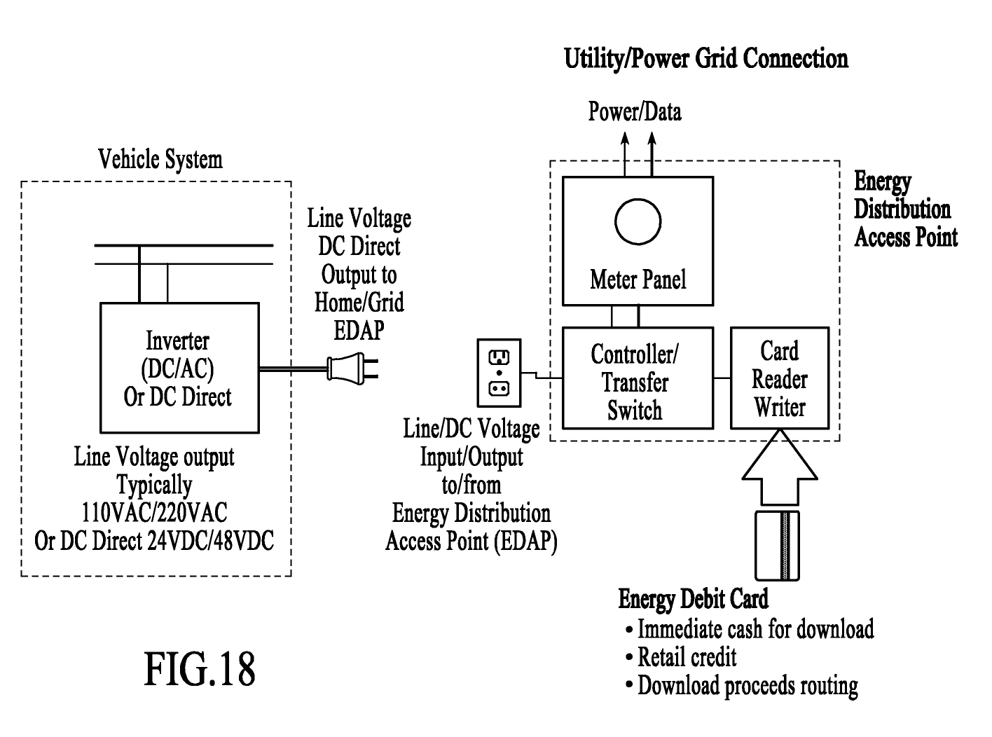

FIG. 18 is a block diagram of the interface to a grid download terminal which has a card, smart card, RFID (Radio Frequency Identification Tag), or similar interface to provide debit or credit transactions to either retail, corporate, government or utility entities, under an embodiment. This embodiment includes a transaction interface which allows a individual to enter user specific identification through for example a credit/debit card to obtain instant reimbursement of the energy downloaded. As energy is measurable and immediately consumed, value can be immediately provided to the individual.

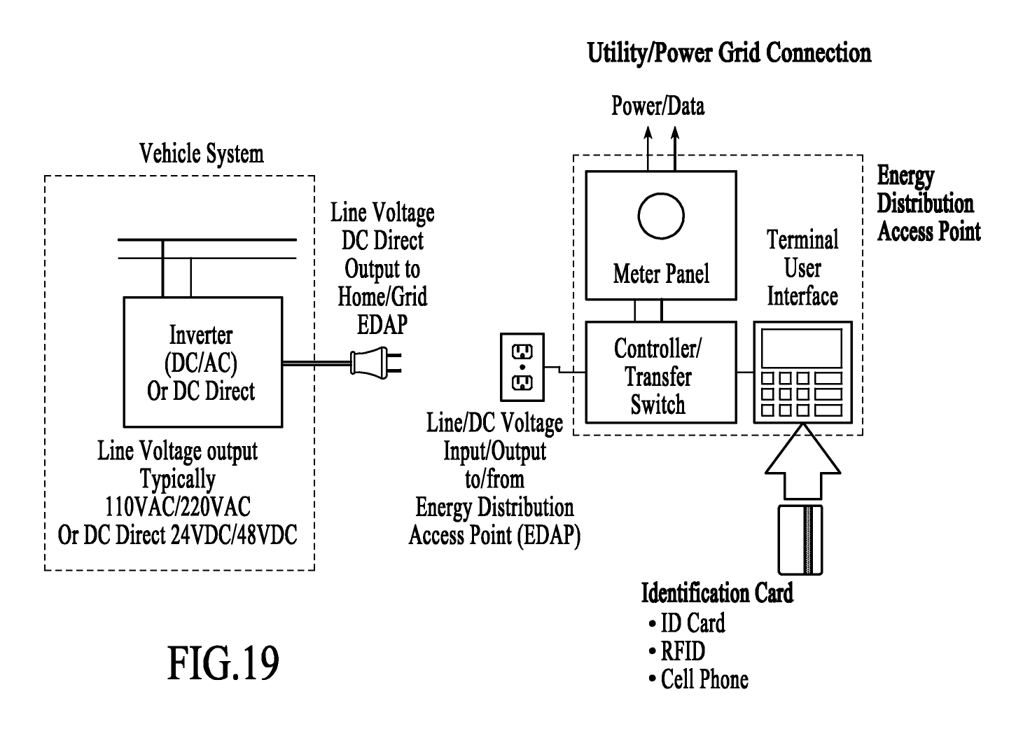

FIG. 19 is a block diagram of the interface to a grid download terminal which has a user interface terminal and can also provide transaction authentication via Cellular telephone, under an embodiment. This embodiment comprises a manual user interface in conjunction with a card interface. This mode can also be implemented discretely where the individual can manually enter the account information to which they would like reimbursement directed.

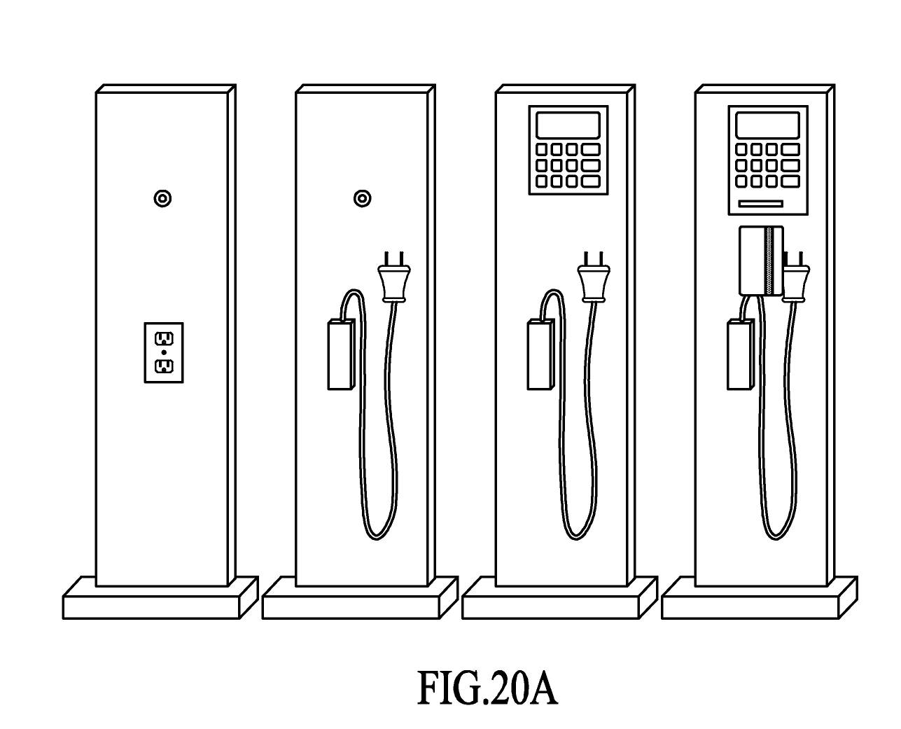

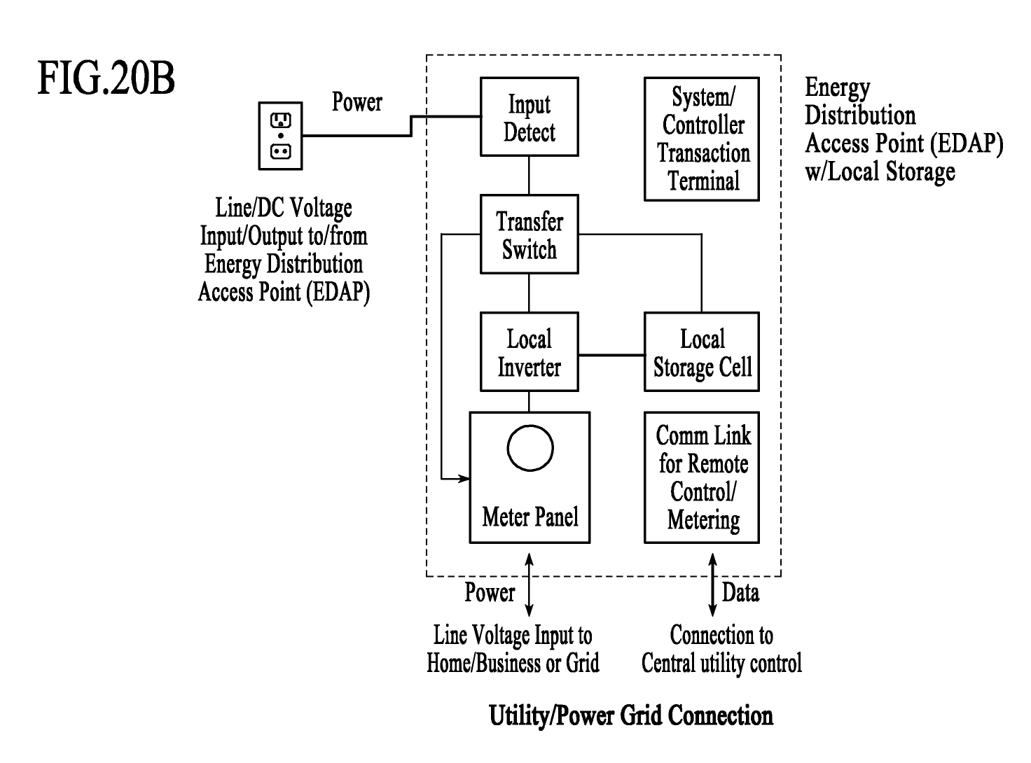

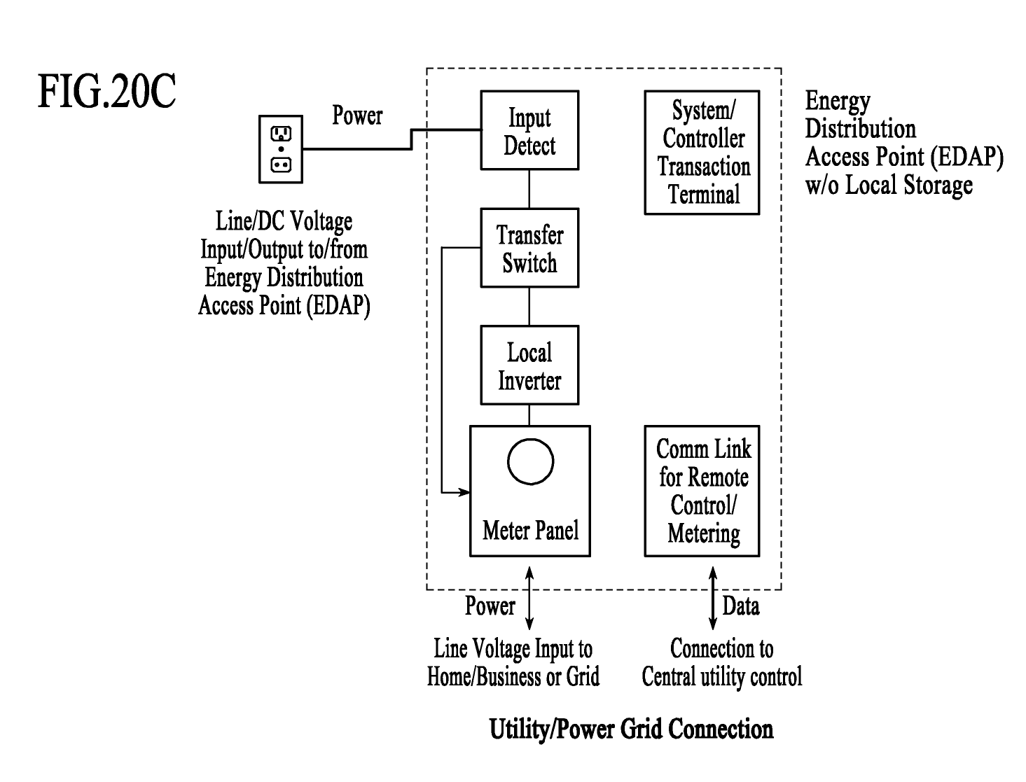

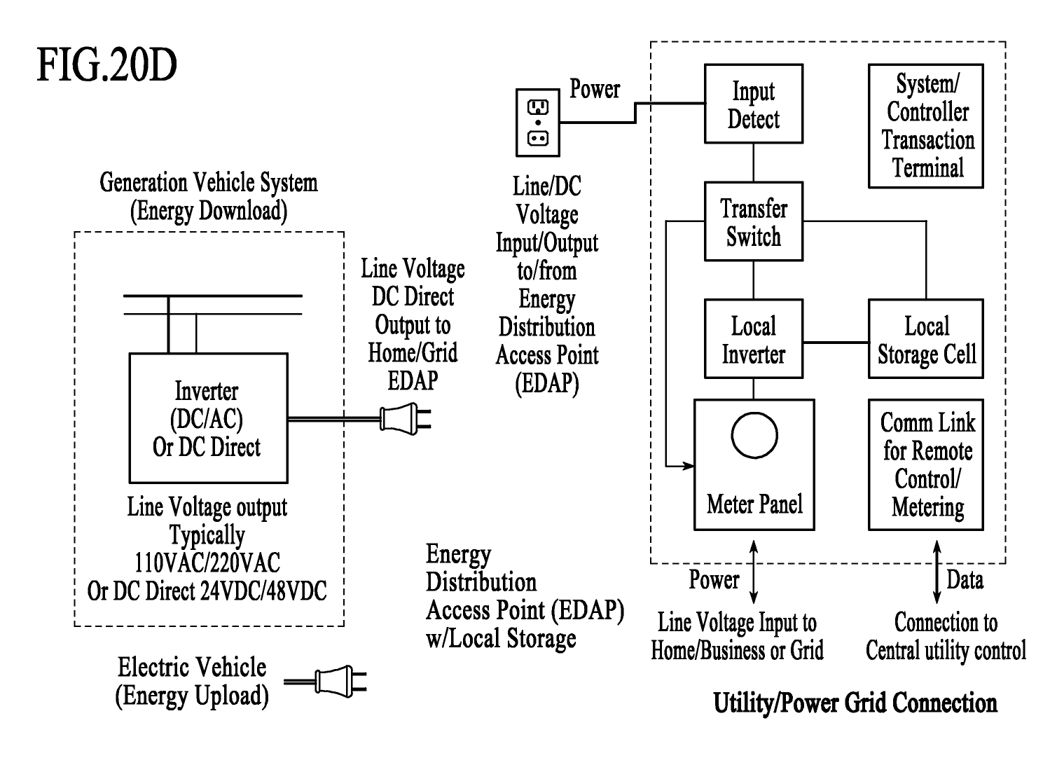

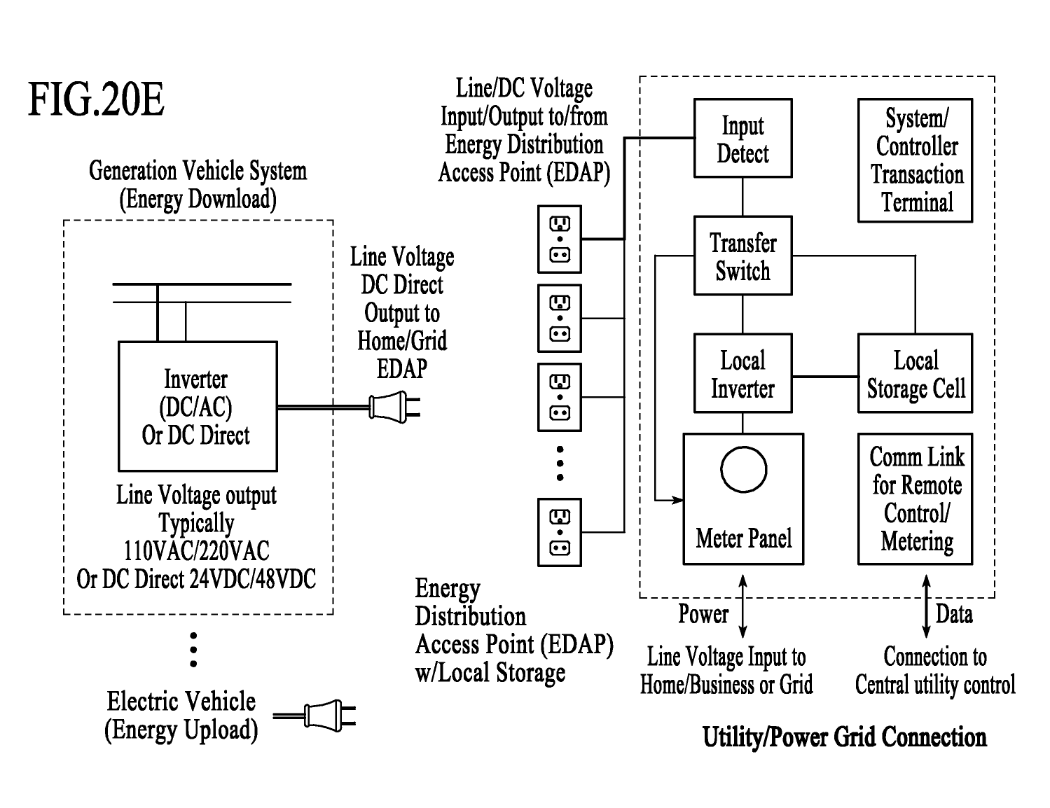

FIG. 20A is a schematic representation of four embodiments of download terminals, under an embodiment.

FIG. 20B is a block diagram of the interface to a single user download/upload energy distribution access point and terminal block diagram, under an embodiment. The download/upload terminal of an embodiment comprises five components or blocks. The first component is an input/output socket. The input/output socket of an embodiment is a derivative of a household line voltage receptacle with the addition of a DC Voltage connector to allow both AC and DC voltage interface and oriented for ease of use or for environmental considerations. The second component is the transfer switch which provides one or more of the following functions: a physical isolation switch from the main power source to that of the vehicle; a transfer from the grid attachment to local storage download; and a managed load modulator to balance the demand on the vehicle when the home or business load increases beyond the vehicles capacity.

The third component of an embodiment is a grid tie inverter which converts local DC storage into AC line voltage. The inverter also synchronizes the system to the frequency, phase and power factor compensation. The inverter also provides short circuit and ground fault protection. The fourth component is the system controller and human interface device (HID) The system controller controls all detection and switching function as well as managing the HID and internal energy counter which provides exact energy (Watts) accumulation data and acts as a reporting conduit to process energy refunds and/or payments. The fifth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business. The Sixth component is the internal storage cells which store downloaded energy for use on demand. The stored energy can be used for distribution through the local grid or back to electric vehicles which attach to the EDAP. The final component is the communications link which allows for external control of the EDAP, data download, software updates, energy transaction verification and authentication as well as other functions, under an embodiment.

FIG. 20C is a block diagram of the interface to a single user download/upload energy distribution access point and terminal block diagram, under an embodiment. The download/upload terminal of an embodiment comprises five components or blocks. The first component is an input/output socket. The input/output socket of an embodiment is a derivative of a household line voltage receptacle with the addition of a DC Voltage connector to allow both AC and DC voltage interface and oriented for ease of use or for environmental considerations. The second component is the transfer switch which provides one or more of the following functions: a physical isolation switch from the main power source to that of the vehicle; a transfer from the grid attachment to local vehicle storage upload; and a managed load modulator to balance the demand on the vehicle when the home or business load increases beyond the vehicles capacity.

The third component of an embodiment is a grid tie inverter which converts local DC storage into AC line voltage. The inverter also synchronizes the system to the frequency, phase and power factor compensation. The inverter also provides short circuit and ground fault protection. The fourth component is the system controller and human interface device (HID) The system controller controls all detection and switching function as well as managing the HID and internal energy counter which provides exact energy (Watts) accumulation data and acts as a reporting conduit to process energy refunds and/or payments. The fifth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business. The final component is the communications link which allows for external control of the EDAP, data download, software updates, energy transaction verification and authentication as well as other functions, under an embodiment.

FIG. 20D is a block diagram of the interface to a single user download/upload energy distribution access point and terminal block diagram, under an embodiment. The download/upload terminal of an embodiment comprises five components or blocks. The first component is an input/output socket. The input/output socket of an embodiment is a derivative of a household line voltage receptacle with the addition of a DC Voltage connector to allow both AC and DC voltage interface and oriented for ease of use or for environmental considerations. The second component is the transfer switch which provides one or more of the following functions: a physical isolation switch from the main power source to that of the vehicle; a transfer from the grid attachment to local storage download; and a managed load modulator to balance the demand on the vehicle when the home or business load increases beyond the vehicles capacity.

The third component of an embodiment is a grid tie inverter which converts local DC storage into AC line voltage. The inverter also synchronizes the system to the frequency, phase and power factor compensation. The inverter also provides short circuit and ground fault protection. The fourth component is the system controller and human interface device (HID) The system controller controls all detection and switching function as well as managing the HID and internal energy counter which provides exact energy (Watts) accumulation data and acts as a reporting conduit to process energy refunds and/or payments. The fifth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business. The Sixth component is the internal storage cells which store downloaded energy for use on demand. The stored energy can be used for distribution through the local grid or back to electric vehicles which attach to the EDAP. The final component is the communications link which allows for external control of the EDAP, data download, software updates, energy transaction verification and authentication as well as other functions. The Block diagram shows the ability to connect to either or both downloading vehicles as well as uploading vehicles, under an embodiment.

FIG. 20E is a block diagram of the interface to a multi user download/upload energy distribution access point and terminal block diagram, under an embodiment. The download/upload terminal of an embodiment comprises five components or blocks. The first component is an input/output socket. A plurality of input/output sockets of an embodiment is a derivative of a household line voltage receptacle with the addition of a DC Voltage connector to allow both AC and DC voltage interface and oriented for ease of use or for environmental considerations. The second component is the transfer switch which provides one or more of the following functions: a physical isolation switch from the main power source to that of the vehicle; a transfer from the grid attachment to local storage download; and a managed load modulator to balance the demand on the vehicle when the home or business load increases beyond the vehicles capacity.

The third component of an embodiment is a grid tie inverter which converts local DC storage into AC line voltage. The inverter also synchronizes the system to the frequency, phase and power factor compensation. The inverter also provides short circuit and ground fault protection. The fourth component is the system controller and human interface device (HID) The system controller controls all detection and switching function as well as managing the HID and internal energy counter which provides exact energy (Watts) accumulation data and acts as a reporting conduit to process energy refunds and/or payments. The fifth component of an embodiment is the main meter interface which can be used in circumstances where the system is isolated and does not have access to a data link. The meter serves as the electro mechanical accumulator for energy download tracking. The meter also serves its normal function to provide a measurement of incoming energy into the home or business. The Sixth component is the internal storage cells which store downloaded energy for use on demand. The stored energy can be used for distribution through the local grid or back to electric vehicles which attach to the EDAP. The final component is the communications link which allows for external control of the EDAP, data download, software updates, energy transaction verification and authentication as well as other functions. The Block diagram shows the ability to connect to either or both downloading vehicles as well as uploading vehicles, under an embodiment.

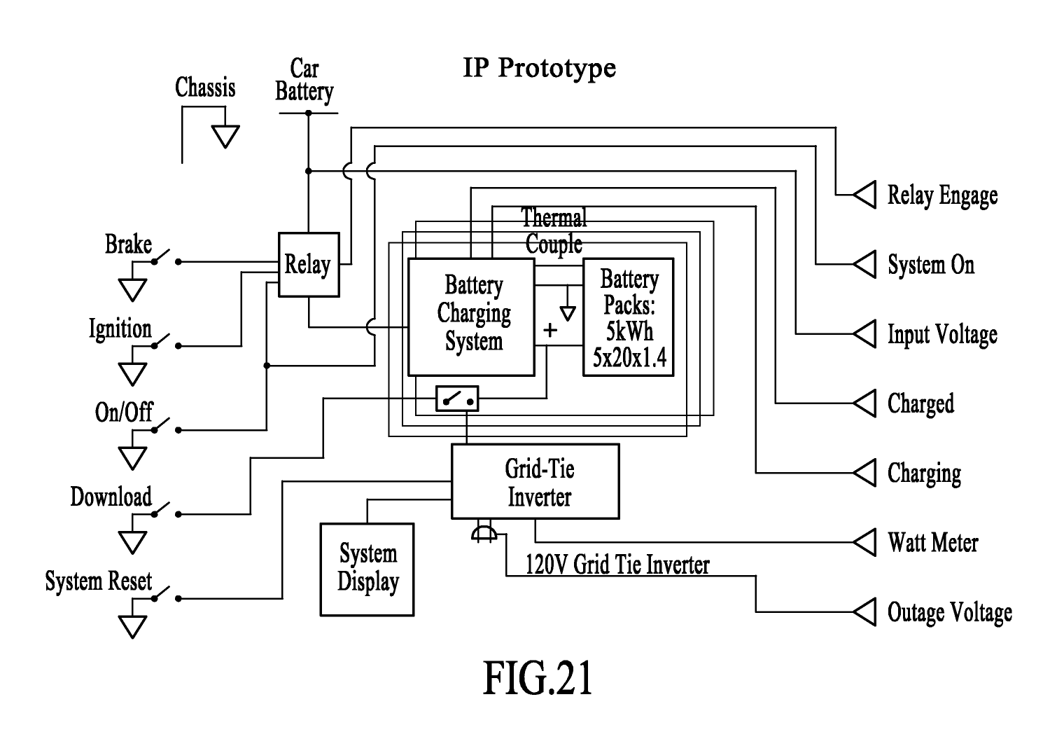

A more specific example of the ECS is described below as an example embodiment. FIG. 21 is a block diagram of the ECS system, under an embodiment. The ECS system is coupled or connected to the vehicle via a coupling or connection to an in-vehicle charging circuit such as an alternator or independent generator connected to the vehicle drive/braking system. The ECS system includes inputs to create operational fail safes. Furthermore, to optimize energy transfer, the ECS system samples several additional inputs, which control the timing of energy transfer. The ECS system of an embodiment comprises, but is not limited to, a system base, a Grid Tie Inverter (GTI), a storage cell, and a system monitor. Each of these components is described in detail below.

The system base is a sheet metal structural frame that provides a chassis for the GTI and wiring interconnect. The system base also provides a mounting frame for all system components, a protective shell for all system components, and a heat dissipation vehicle for the system under charging/discharging.

The GTI converts the stored kinetic energy in the batteries from a low voltage DC format to a line voltage AC format. Additionally, the GTI synchronizes the AC power output to the utility line voltage characteristics (e.g., frequency, phase, voltage, etc.).

The storage cell comprises a battery, the chemistry of which is selected to maximize capacity, storage cycles, and minimize weight per kilowatt-hour (kWHr). The chemistry of the storage cell of an embodiment is Lithium-Ion but is not so limited as the storage cell chemistry is agnostic to the system. The storage cell also includes a battery management circuit that manages or controls the charging of the battery to minimize charging time, and thermal output, while simultaneously maximizing battery life and current output. The storage cell has the ability via an indicator light to display when the cell is at end of life and/or its relative efficiency.

The system monitor provides real time indications of system status and energy production. The system monitor displays such values as total KWHr generated, generation rate, average generation, input voltage, output voltage, system temperature, etc.

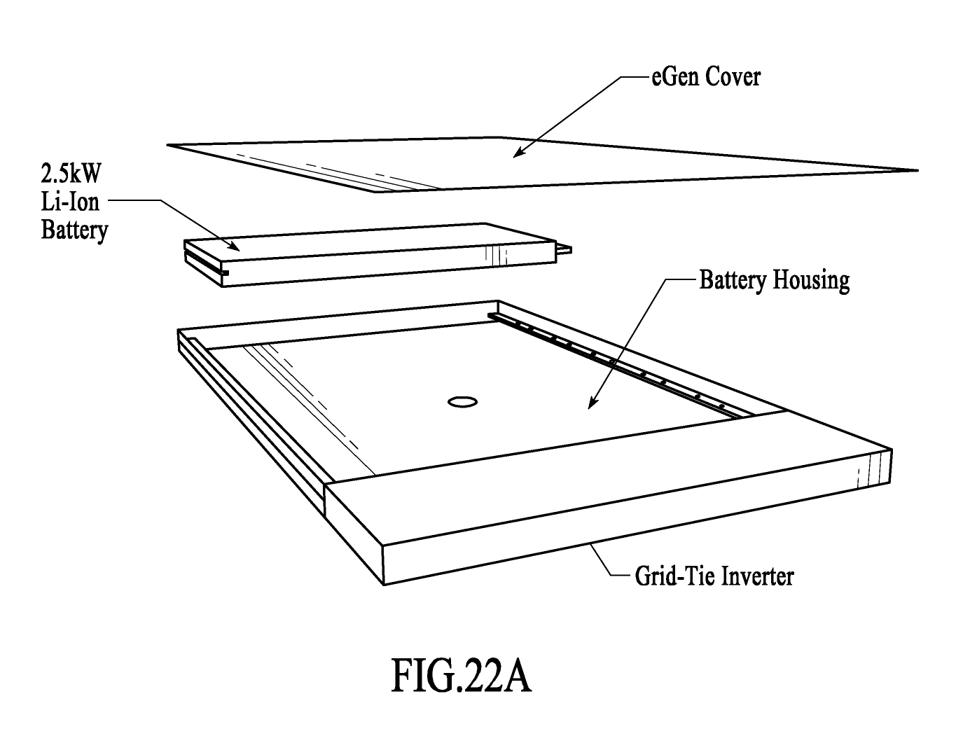

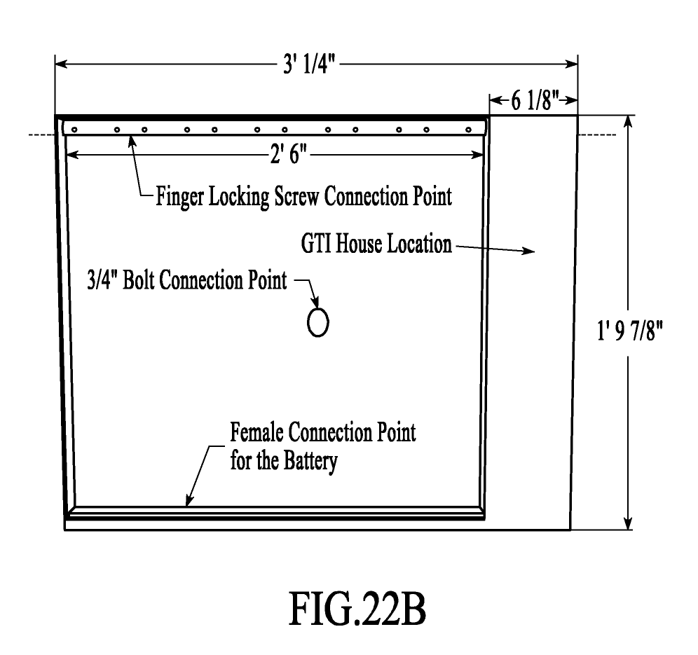

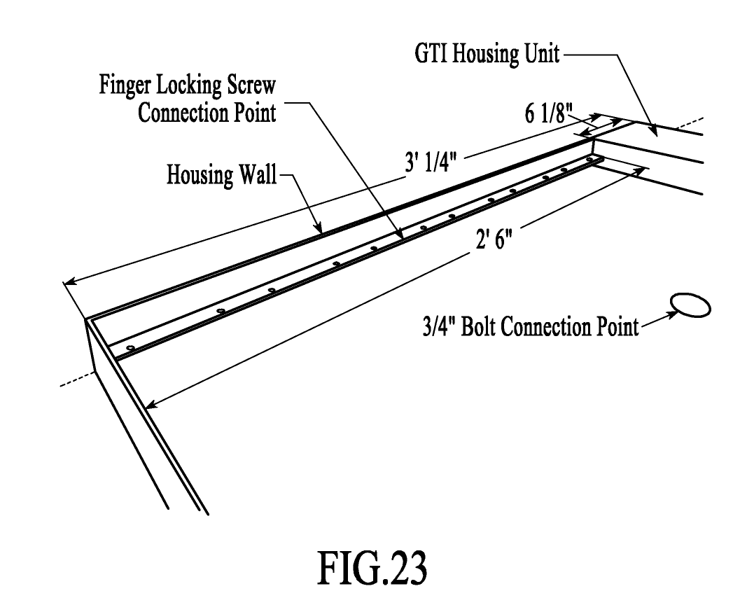

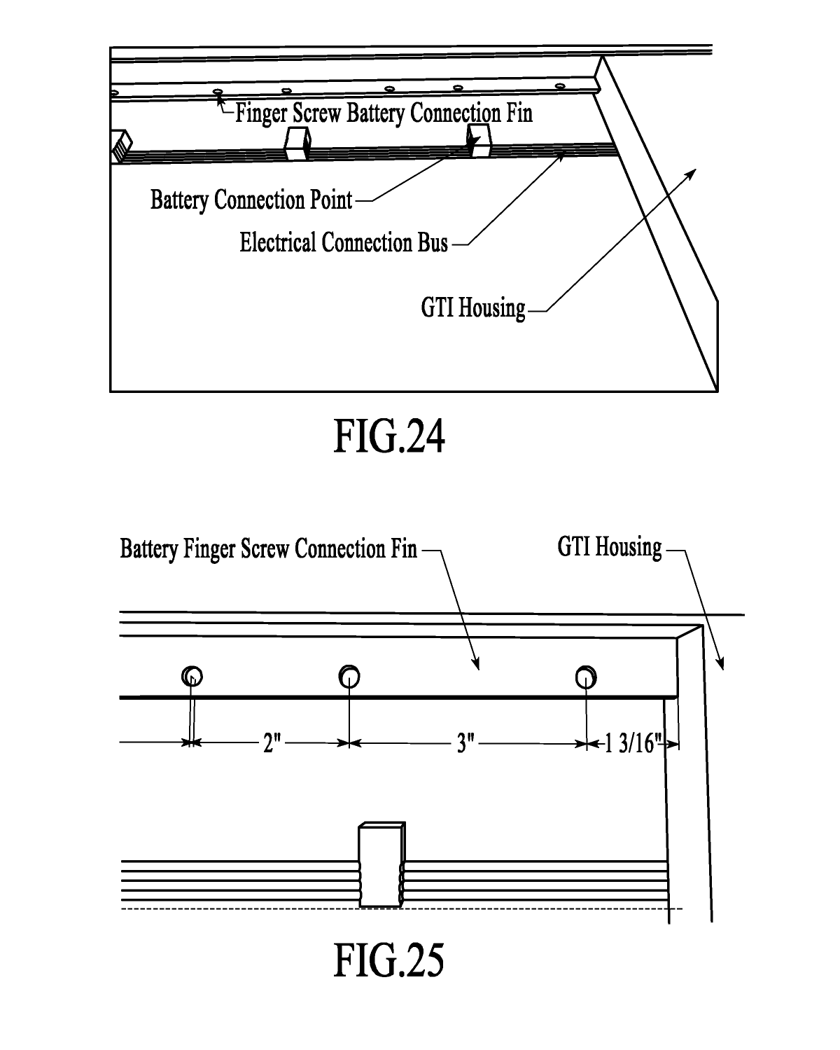

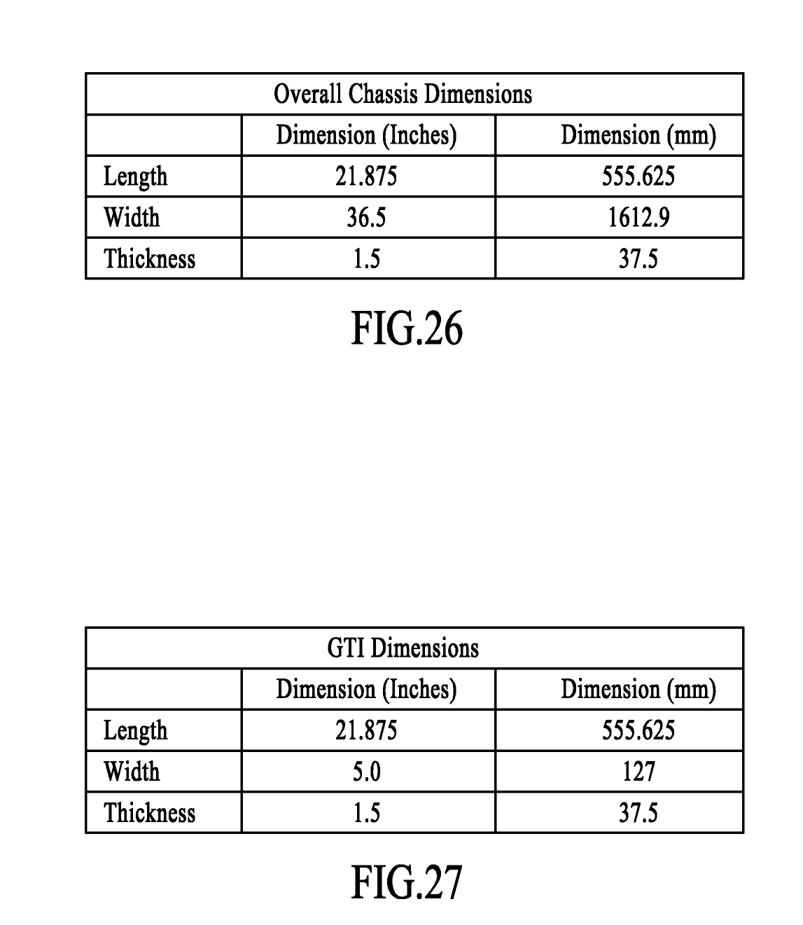

The system base, or chassis, of an embodiment comprises a structure of annodized aluminum. The layout of the chassis includes a set of uniform slots which are populated with a standard size storage cell as described below. These slots are oriented from left to right and terminate against an integrated GTI/Controller unit which is part of the chassis. The GTI is located in an enclosed space (for example, the space can have dimensions of approximately 6″×21⅞″×1½′″) on the right side of the main chassis structure. A first side of the housing unit includes a metal tab (e.g., ⅛″ thick by 1″ wide, located ⅞″ from the bottom) that runs the length of the open slot side of the unit. The metal tab has threaded holes (e.g., sized at ⅛″ in diameter) that are spaced to accommodate one or more batteries (e.g., a 5″ wide battery and a 10″ wide battery). A second side of the chassis unit is the female connection point for the battery (e.g., the female connection is ¼″ bent aluminum running the length of the chassis enclosure, with a fin base located ¾″ from the base of the chassis and extending ½″). The chassis unit is attached to the vehicle via an attachment (e.g., one ¾″ hollow all-thread bolt located at the center of the base of the chassis). FIG. 22A is a system mechanical schematic, under an embodiment. FIG. 22B is a top view of the chassis, under an embodiment. FIG. 23 is a side wall view of the chassis, under an embodiment. FIG. 24 shows the chassis bus structure, under an embodiment. FIG. 25 shows the connector spacing of the chassis, under an embodiment. FIG. 26 is a table of the overall chassis dimensions, under an embodiment. FIG. 27 is a table of the GTI dimensions, under an embodiment.

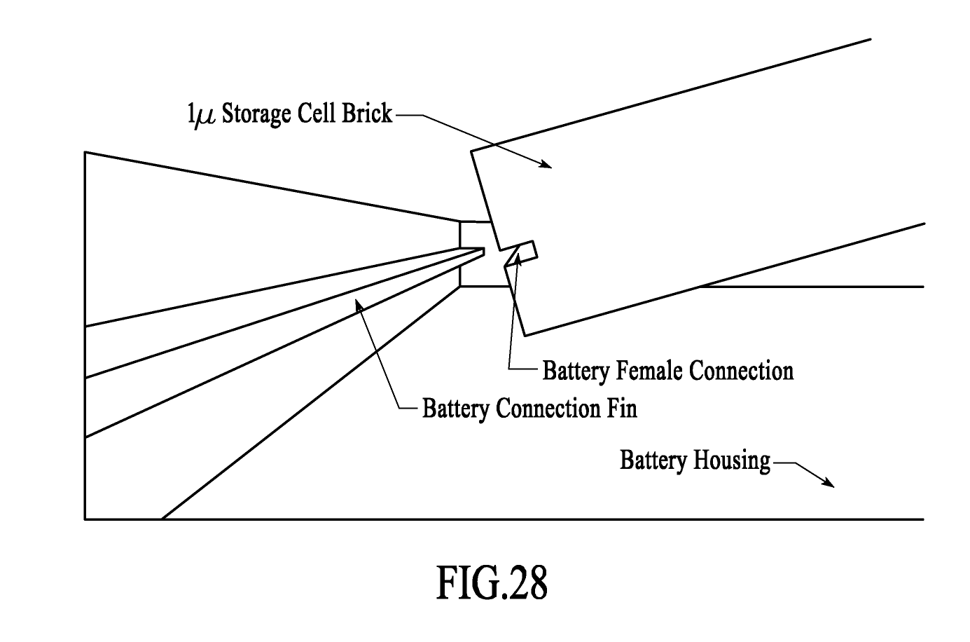

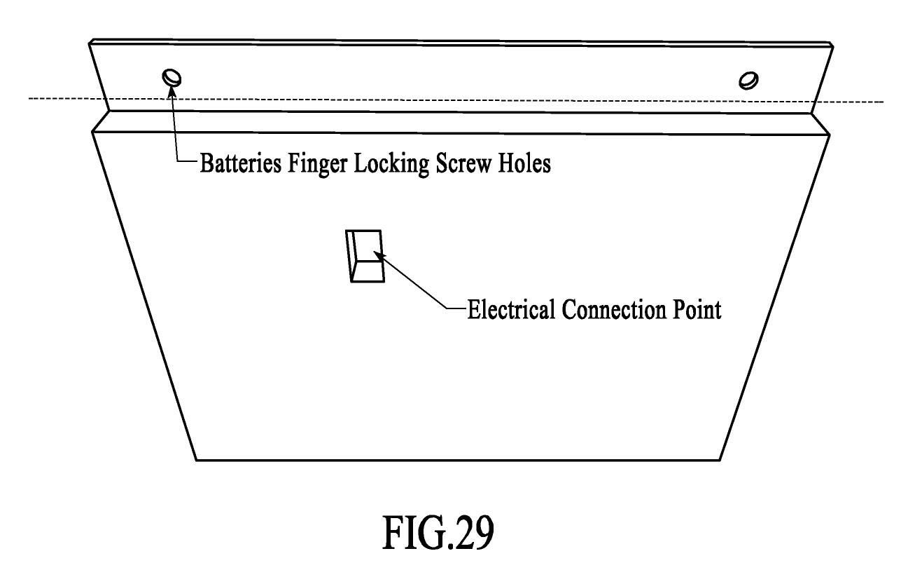

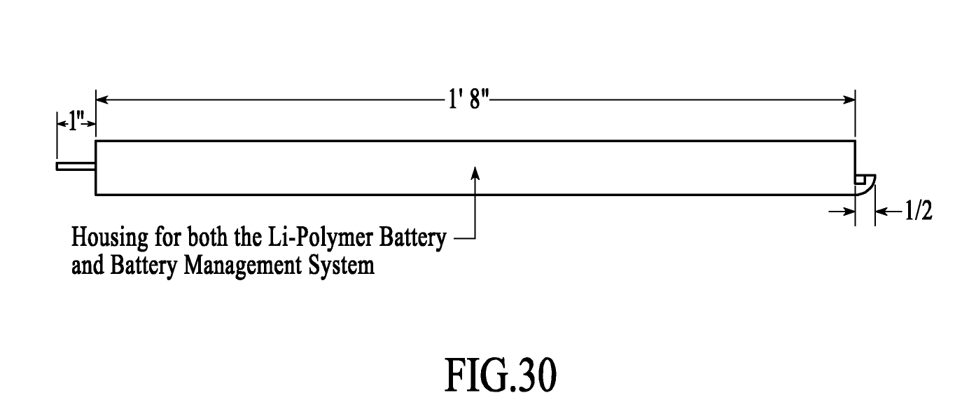

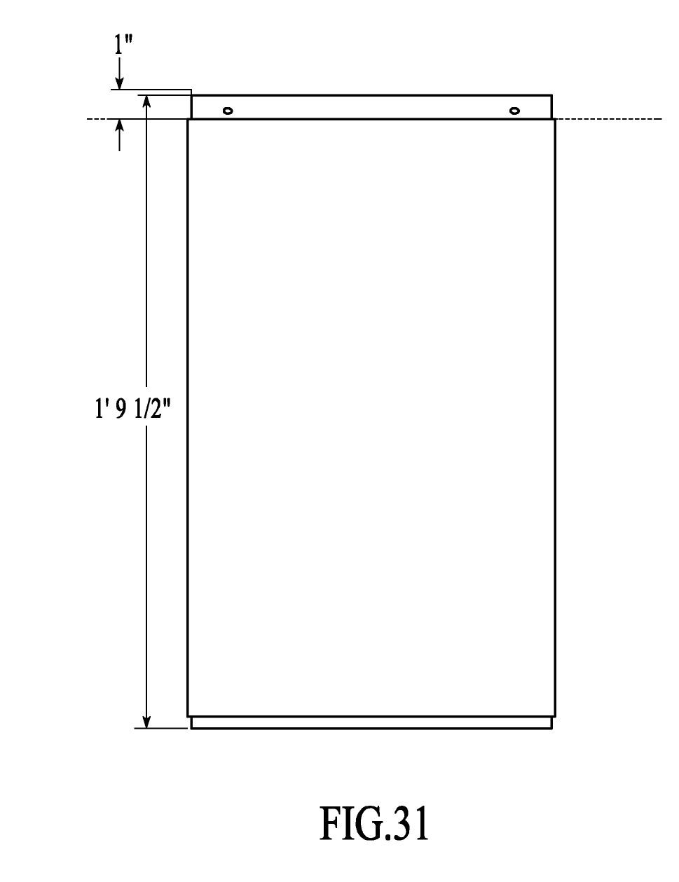

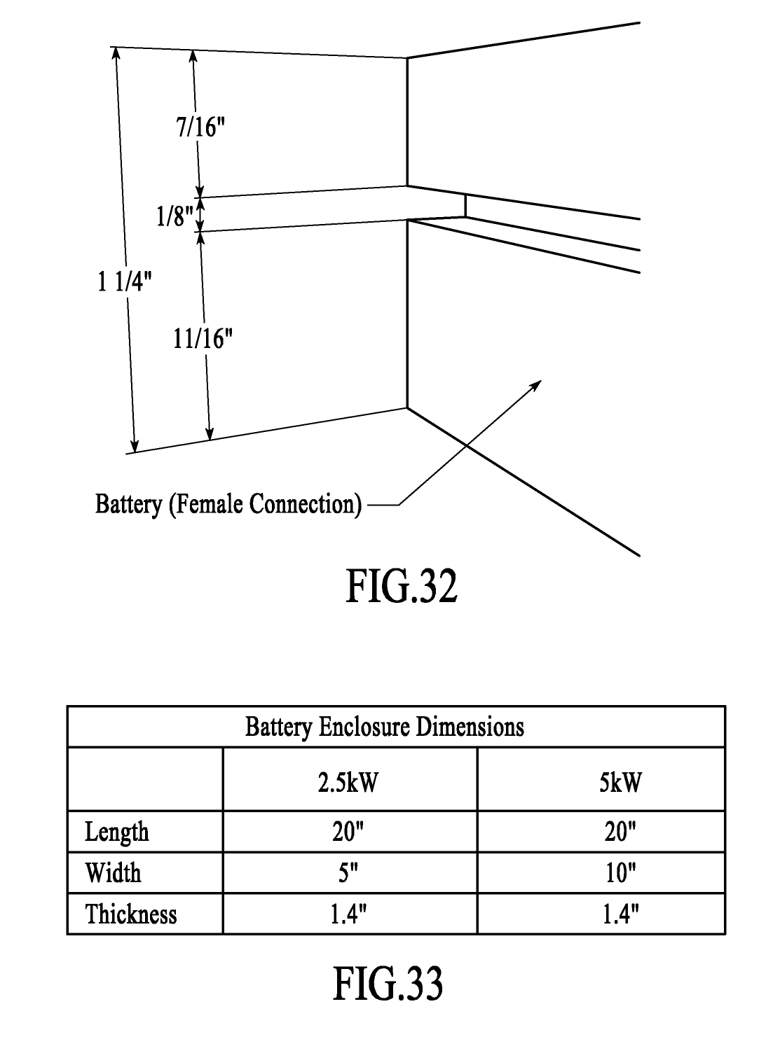

The storage cell of an embodiment comprises the following components but is not so limited: a housing for the Lithium Polymer materials and battery management system; a locking connection to the housing; and a retainer mechanism. FIG. 28 is a mechanical interface between the chassis and storage cell, under an embodiment. FIG. 29 shows the storage cell connection detail, under an embodiment. FIG. 30 is a side view of the storage cell, under an embodiment. FIG. 31 is a top view of the storage cell, under an embodiment. FIG. 32 shows the storage cell mating slot, under an embodiment. FIG. 33 is a table of battery enclosure dimensions, under an embodiment.

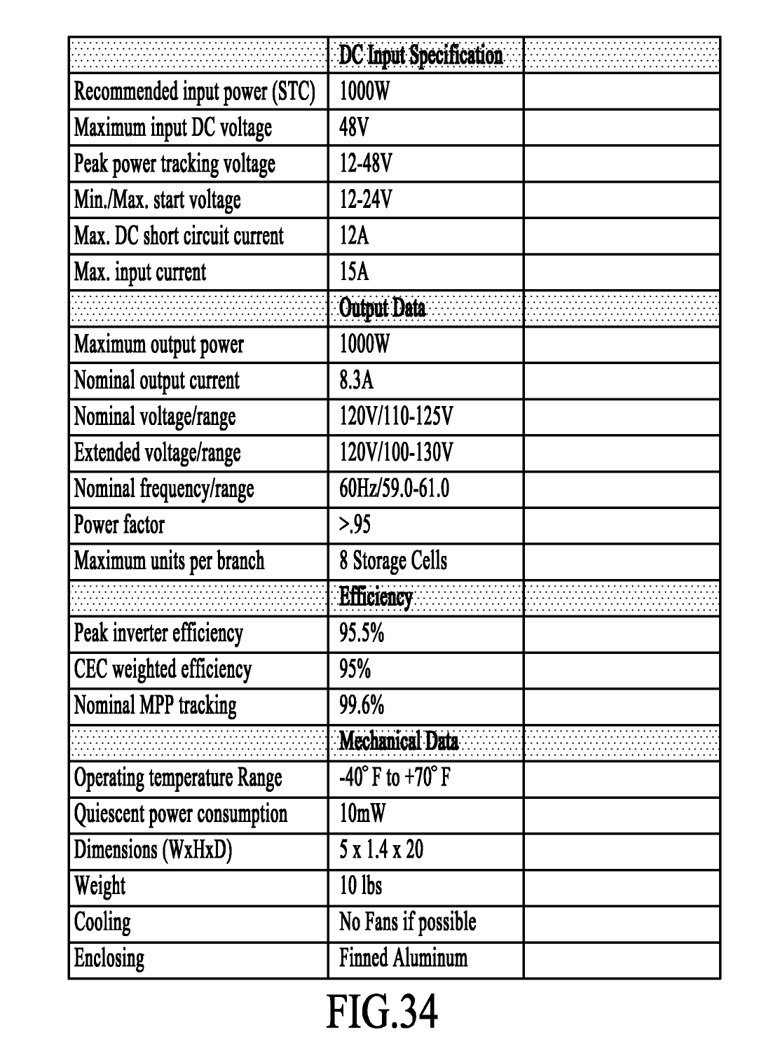

The Grid Tie Inverter (GTI) of an embodiment converts the DC power source from the system battery array into line voltage AC in a pure sine wave format. The GTI also synchronizes the output of the inverter to the local power grid. This synchronization includes adjusting or controlling the frequency, phase and power factor of the output. The GTI manages or controls the current output to ensure the optimum download rate into the power grid while managing thermal and battery chemistry limitations to preserve maximum battery life and efficiency. Couplings or connections to the GTI include, but are not limited to, the following: a high voltage pig tail which can be surface mounted to the car chassis or positioned in the mounting area in the trunk of a host vehicle; a connector to tie into the chassis storage cell bus, which includes the data bus; a connector to the system display. The controller for the system is located in the GTI. FIG. 34 is a table of the GTI specifications, under an embodiment.

The storage cell of an embodiment is a battery subsystem, which is expandable in the system in two increments of width. Each increment of storage cell adds approximately 2.5 kWh of capacity with the maximum capacity of 20 kWh or 40″ of horizontal chassis width. The two increments include a 1 U “brick” measuring 5″×20″×1.4″ and a 2 U Brick which doubles the width of the 1 U or 10″×20″×1.4″.

The storage cell is configured around the principle of complete reuse and recyclable materials. The components of the storage cell are reusable and provide long operational life as well as ease of disassembly and reassembly. The 1 U and 2 U bricks enable rapid disassembly, reassembly and final testing. The storage cell includes including connections to the battery material, which precludes the need for soldering and desoldering, and ease of battery material separation.

Each storage cell comprises the following components, but the embodiment is not so limited: a reusable clam shell container which houses the storage cell components; the battery charging and discharging circuit board; battery cells. The battery housing as described above comes in two formats as follows: 2.5 KWHr (5″×20″×1.4″ 1 U brick); 5.0 KWHr (10″×20″×1.4″ 2 U brick).

The battery housing includes a commercial use format and three consumer use formats. The standard base battery housing is a molded high impact plastic container having a clam shell form factor with pressure snap connections between the top and bottom halves. These connections are operable by the factory only and incorporate a warrantee violation mechanism. The commercial housing is constructed from recycled aluminum. The housing can also comprise carbon fiber. The housing has two points of connection as described above comprising a formed J-tab which provides the non fastener connection, and a wing tab which secures the housing to the chassis via a mechanical fastener.

The housing incorporates a waterproof connector (automotive rated), which connects the chassis bus to the battery charging/discharging circuit board. This connector is a standard connector, which incorporates self-alignment geometry. The connector includes the following couplings or connections: Power (+10V to +16V) PDC unfiltered; chassis ground; Data positive; Data negative. The connector acts as a structural component and forms one of several attachment points for the charging/discharging circuit board. The other connection points provide the heat dissipation mechanism for the circuit board. The housing, upon closing of the clam shell, forms a waterproof/dust proof seal through either a perimeter gasket/o-ring or an equivalent seal.

The battery charging and discharging circuit is battery chemistry-dependent and therefore requires that the same batteries be replaced in the container to maintain compatibility with the charging circuit board. The purpose of the battery charger IC is to take energy from a wide range of sources and to deliver this energy in a controlled manner to the battery. The controlled manner means that the IC is capable of operating in all the necessary modes of charging a battery for portable device: trickle mode, constant current (CC) mode and constant voltage (CV) mode, to name a few.

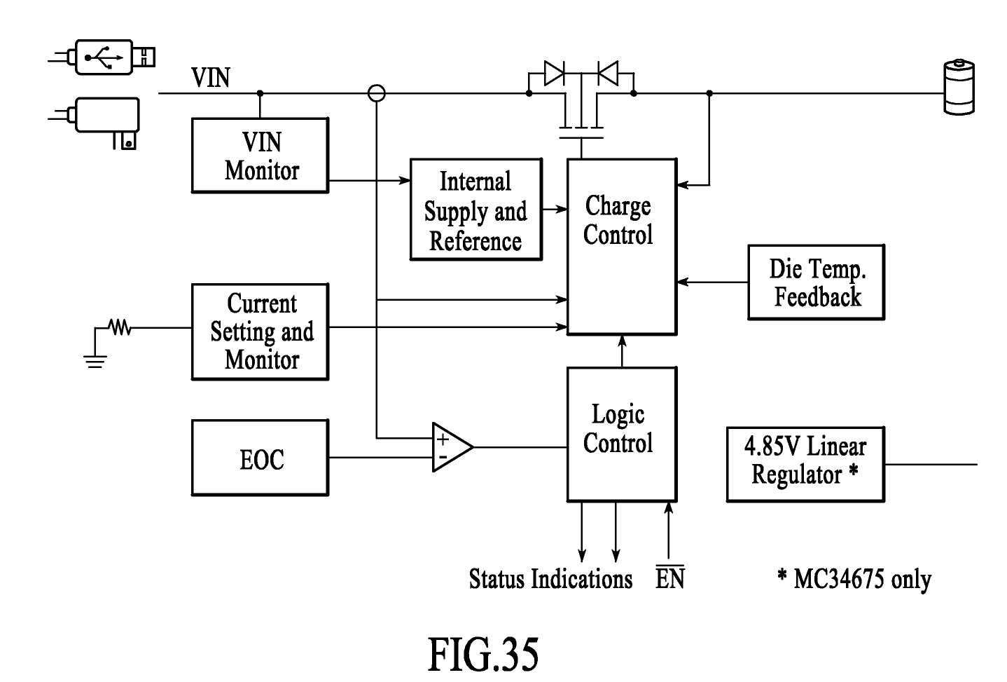

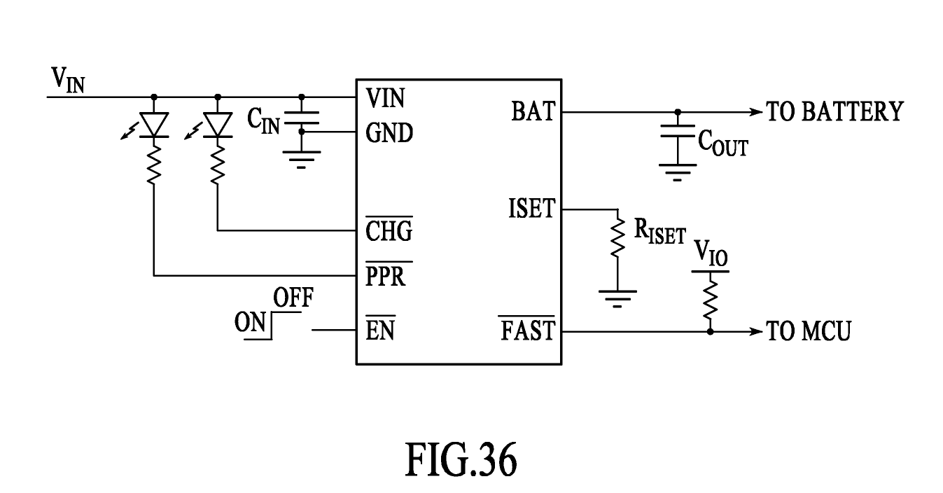

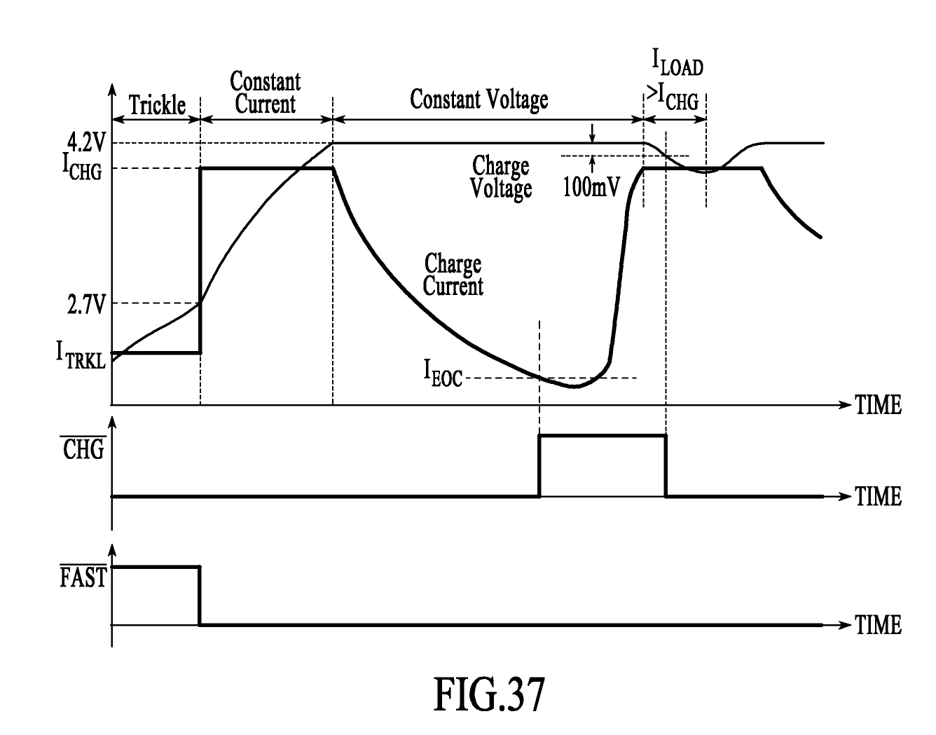

FIG. 35 is a battery charging and discharging circuit, under an embodiment. FIG. 36 is logic control circuitry of the battery charging and discharging circuit, under an embodiment. The battery charging and discharging circuit includes a transistor which is backed up with control and feedback circuitry. The circuit can receive an input as high as 28V (with overvoltage protection) and as low as 2.6V, and it delivers overcurrent protection, together with thermal fold back (with up to +/−0.7% voltage accuracy), features which increase battery lifetime and ensure a full charge cycle of a battery. The circuit is housed in an 8-lead 2 mm×3 mm×0.65 mm. UDFN thermally enhanced package, which also houses other components, for example, the charging FET transistor, blocking diodes and sense resistors. The logic control circuitry enables a precise charging cycle for use in charging totally depleted batteries.

FIG. 38 shows a charging cycle of the battery charging and discharging circuit, under an embodiment. The charging cycle supports three states that are controlled by the circuit: trickle mode, CC mode and CV mode. The charging current is shown along with the charge (battery) voltage. Also shown are the states of two pins of the charger, /CHG and /FAST, which indicate the state of the charging cycle. When the battery is totally depleted, it is charged with a “trickle” current, which is much lower than the normal charging current of the battery. The trickle current value battery charging and discharging circuit is preset to twenty percent of the normal charging current. Trickle current is supplied to the Li-ion or Li-polymer battery until it reaches a voltage of 2.7V. This threshold is detected by the battery charging and discharging circuit (which flags the event by setting the /FAST pin in a LOW state) and, in response, the charging current is controlled to its nominal constant current value. The constant current value is set with the help of an external resistor; using this resistor (R_ISET), the current for the battery charging and discharging circuit is set (e.g., set for up to 600 mA, 1.2 A or 1 A.

When battery voltage reaches 4.2V, the battery charging and discharging circuit switches to CV mode, and regulates not the current through its internal FET but rather its output voltage. This is regulated to 4.2V and the charging current gradually drops until it reaches a threshold called End-Of-Charge (EOC). This threshold is preset to 10% of the nominal constant current value used in the previous phase. When this point in time is reached, the /CHG pin of the charger is switched to a high state, in order to indicate to a potential controller the fact that battery charging has completed. Although charging is complete, the charger continues to monitor the state of the battery. If a load occurs in parallel to the battery, the charger supplies current to the load, rather than the battery. In case the current required by the load exceeds the value for the constant current which was set with the external resistor, the battery supplies the additional current. In case the battery voltage drops below a specific “recharge level” the battery charger will return to the constant current charge mode, which is being indicated by the /CHG pin. Taking into account these successive charging phases, the charger is also regarded as a state machine.

Embodiments described herein include a vehicle system comprising an energy converter connected to a powertrain component of a powertrain of a vehicle via a connection component. The energy converter comprises converter circuitry that converts kinetic energy of the vehicle to electrical energy. The vehicle system includes an energy storage cell coupled to the generator. The energy storage cell stores the electrical energy. The vehicle system includes an energy translator coupled to the energy storage cell and the energy converter. The energy translator comprises translator circuitry that converts the electrical energy of the storage cell into line voltage electricity.

Embodiments described herein include a vehicle system comprising: an energy converter connected to a powertrain component of a powertrain of a vehicle via a connection component, the energy converter comprising converter circuitry that converts kinetic energy of the vehicle to electrical energy; an energy storage cell coupled to the generator, the energy storage cell storing the electrical energy; and an energy translator coupled to the energy storage cell and the energy converter, the energy translator comprising translator circuitry that converts the electrical energy of the storage cell into line voltage electricity.

The vehicle system of an embodiment comprises a controller coupled to the powertrain component and the energy translator.

The controller of an embodiment, in response to a signal from the powertrain component, controls the converter circuitry to induce a variable load on the powertrain that converts the kinetic energy to the electrical energy.

The variable load of an embodiment is charging of the energy storage cell.

The signal of an embodiment from the powertrain component indicates a reduction in velocity of the vehicle.

The controller of an embodiment varies the variable load to generate the reduction in the velocity of the vehicle.

The signal of an embodiment from the powertrain component indicates a constant velocity of the vehicle.

The controller of an embodiment varies the variable load to generate the constant velocity of the vehicle.

The signal of an embodiment from the powertrain component indicates a turning of the vehicle.

The controller of an embodiment varies the variable load to stabilize the vehicle in the turn.

The signal of an embodiment from the powertrain component indicates absence of motion of the vehicle.

The controller of an embodiment controls conversion of available output of the energy converter to the electrical energy.

The energy converter of an embodiment is a generator.

The energy converter of an embodiment is a plurality of generators.

The energy converter of an embodiment is an alternator.

The energy converter of an embodiment is a plurality of alternators.

The powertrain component of an embodiment is an engine.

The powertrain component of an embodiment is a transmission.

The powertrain component of an embodiment is a drive shaft.

The powertrain component of an embodiment is a wheel.

The powertrain component of an embodiment is an axle.

The powertrain component of an embodiment is a brake component.

The powertrain component of an embodiment is an accelerometer.

The powertrain component of an embodiment is a velocity sensor.

The electrical energy of an embodiment generated by the energy converter is direct current (DC) electrical energy.

The translator circuitry of an embodiment converts the direct current (DC) electrical energy to the line voltage electricity that is alternating current (AC) electrical energy.

The translator circuitry of an embodiment comprises at least one of short detection circuitry, ground fault detection circuitry, and surge suppression.

The translator circuitry of an embodiment comprises at least one of charge rate control circuitry, storage cell temperature control circuitry, and charge cycle depth control circuitry.

The vehicle system of an embodiment comprises an energy distribution access point (EDAP) connected to an electric grid, wherein the energy translator connects to the EDAP and transfers the line voltage electricity to EDAP circuitry, wherein the EDAP circuitry distributes the line voltage electricity through the electric grid.

The translator circuitry of an embodiment matches at least one component of the line voltage electricity to the EDAP.

The at least one component of an embodiment is voltage level.

The at least one component of an embodiment is frequency.

The at least one component of an embodiment is phase.

The EDAP of an embodiment is connected to the electric grid using a direct connection through which the line voltage electricity that is alternating current (AC) electrical energy is downloaded directly into the electric grid.

The EDAP of an embodiment is connected to the electric grid using a remote control download connection through which the line voltage electricity that is direct current (DC) electrical energy is downloaded into storage cells of the EDAP.

Embodiments described herein include a system comprising an energy converter connected to a powertrain component of a vehicle via a connection component. The energy converter comprises converter circuitry that converts kinetic energy of the vehicle to electrical energy. The system of an embodiment includes an energy storage cell coupled to the generator. The energy storage cell stores the electrical energy. The system of an embodiment includes an energy translator coupled to the energy storage cell and the energy converter. The energy translator comprises translator circuitry that converts the electrical energy of the storage cell into line voltage electricity. The system of an embodiment includes an energy distribution access point (EDAP) connected to an electric grid. The energy translator connects to the EDAP via a removable connector and transfers the line voltage electricity to EDAP circuitry. The EDAP circuitry distributes the line voltage electricity through the electric grid.

Embodiments described herein include a system comprising: an energy converter connected to a powertrain component of a vehicle via a connection component, the energy converter comprising converter circuitry that converts kinetic energy of the vehicle to electrical energy; an energy storage cell coupled to the generator, the energy storage cell storing the electrical energy; an energy translator coupled to the energy storage cell and the energy converter, the energy translator comprising translator circuitry that converts the electrical energy of the storage cell into line voltage electricity; and an energy distribution access point (EDAP) connected to an electric grid, wherein the energy translator connects to the EDAP via a removable connector and transfers the line voltage electricity to EDAP circuitry, wherein the EDAP circuitry distributes the line voltage electricity through the electric grid.

The system of an embodiment comprises a controller coupled to the powertrain component and the energy translator, wherein the controller, in response to a signal from the powertrain component, controls the converter circuitry to induce a variable load on the powertrain that converts the kinetic energy to the electrical energy, wherein the variable load is charging of the energy storage cell.

The signal of an embodiment from the powertrain component indicates a reduction in velocity of the vehicle, wherein the controller varies the variable load to generate the reduction in the velocity of the vehicle.

The signal of an embodiment from the powertrain component indicates a constant velocity of the vehicle, wherein the controller varies the variable load to generate the constant velocity of the vehicle.

The signal of an embodiment from the powertrain component indicates a turning of the vehicle, wherein the controller varies the variable load to stabilize the vehicle in the turn.

The controller of an embodiment controls conversion of available output of the energy converter to the electrical energy.

The energy converter of an embodiment is at least one of a generator, a plurality of generators, an alternator, and a plurality of alternators.

The powertrain component of an embodiment is at least one of an engine, a transmission, a drive shaft, a wheel, an axle, a brake component, an accelerometer, a velocity sensor.

The electrical energy of an embodiment generated by the energy converter is direct current (DC) electrical energy, wherein the translator circuitry converts the direct current (DC) electrical energy to the line voltage electricity that is alternating current (AC) electrical energy.

The translator circuitry of an embodiment matches a component of the line voltage electricity to the EDAP, wherein the component is at least one of voltage level, frequency, and phase.

The EDAP of an embodiment is connected to the electric grid using a direct connection through which the line voltage electricity that is alternating current (AC) electrical energy is downloaded directly into the electric grid.

The EDAP of an embodiment is connected to the electric grid using a remote control download connection through which the line voltage electricity that is direct current (DC) electrical energy is downloaded into storage cells of the EDAP.

Embodiments described herein include a vehicle system comprising an energy converter connected to a powertrain component of a vehicle via a connection component. The energy converter comprises converter circuitry that converts kinetic energy of the vehicle to electrical energy. The vehicle system of an embodiment comprises an energy storage cell coupled to the generator. The energy storage cell stores the electrical energy. The vehicle system of an embodiment comprises an energy translator coupled to the energy storage cell and the energy converter. The energy translator comprises translator circuitry that converts the electrical energy of the storage cell into line voltage electricity. The vehicle system of an embodiment comprises a controller coupled to the powertrain component and the energy translator. The controller, in response to a signal from the powertrain component, controls the converter circuitry to induce a variable load on the powertrain that converts the kinetic energy to the electrical energy. The variable load is charging of the energy storage cell.

Embodiments described herein include a vehicle system comprising: an energy converter connected to a powertrain component of a vehicle via a connection component, the energy converter comprising converter circuitry that converts kinetic energy of the vehicle to electrical energy; an energy storage cell coupled to the generator, the energy storage cell storing the electrical energy; an energy translator coupled to the energy storage cell and the energy converter, the energy translator comprising translator circuitry that converts the electrical energy of the storage cell into line voltage electricity; and a controller coupled to the powertrain component and the energy translator, wherein the controller, in response to a signal from the powertrain component, controls the converter circuitry to induce a variable load on the powertrain that converts the kinetic energy to the electrical energy, wherein the variable load is charging of the energy storage cell.

Embodiments described herein include a method for generating power, the method comprising receiving a signal from a powertrain component of a powertrain of a vehicle. The signal represents a state of the powertrain. The method of an embodiment comprises inducing and controlling a variable load on the powertrain in response to the state of the powertrain. The method of an embodiment comprises extracting kinetic energy from the vehicle via the variable load. The method of an embodiment comprises converting the kinetic energy to electrical energy; and storing the electrical energy in the vehicle.

Embodiments described herein include a method for generating power, the method comprising: receiving a signal from a powertrain component of a powertrain of a vehicle, wherein the signal represents a state of the powertrain; inducing and controlling a variable load on the powertrain in response to the state of the powertrain; extracting kinetic energy from the vehicle via the variable load; converting the kinetic energy to electrical energy; and storing the electrical energy in the vehicle.

The method of an embodiment comprises converting the stored electrical energy into line voltage electricity. The method of an embodiment comprises distributing the line voltage electricity to an electric grid.

The electrical energy of an embodiment is direct current (DC) electrical energy.

The converting of an embodiment of the stored electrical energy into the line voltage electricity comprises converting the DC electrical energy to alternating current (AC) electrical energy.

The method of an embodiment comprises matching a component of the line voltage electricity to the electric grid, wherein the component comprises at least one of voltage level, frequency, and phase.

The distributing of the line voltage electricity to the electric grid of an embodiment comprises distributing the line voltage using a direct connection through which the line voltage electricity that is alternating current (AC) electrical energy is downloaded directly into the electric grid.

The distributing of the line voltage electricity to the electric grid of an embodiment comprises distributing the line voltage using a remote control download connection through which the line voltage electricity that is direct current (DC) electrical energy is downloaded into storage cells of the electric grid.

The inducing and controlling the variable load of an embodiment comprises controlling a loading of a generator.

The method of an embodiment comprises controlling the state of the powertrain in response to the response to the loading of the generator, wherein the state is at least one of accelerating, decelerating, coasting, stopping, and idling.

The ECS components described herein can be components of a single system, multiple systems, and/or geographically separate systems. The ECS components can also be subcomponents or subsystems of a single system, multiple systems, and/or geographically separate systems. The ECS components can be coupled to one or more other components (not shown) of a host system or a system coupled to the host system.

The ECS of an embodiment includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the ECS, and/or provided by some combination of algorithms. The ECS methods described herein can be implemented in one or more of software algorithm(s), programs, firmware, hardware, components, circuitry, in any combination.

The ECS components can be located together or in separate locations. Communication paths couple the ECS components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the ECS described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the ECS include: microcontrollers with memory (such as electronically erasable programmable read only memory (EEPROM)), embedded microprocessors, firmware, software, etc. Furthermore, aspects of the ECS may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the ECS is not intended to be exhaustive or to limit the systems and methods to the precise forms disclosed. While specific embodiments of, and examples for, the ECS are described herein for illustrative purposes, various equivalent modifications are possible within the scope of the systems and methods, as those skilled in the relevant art will recognize. The teachings of the ECS provided herein can be applied to other systems and methods, not only for the systems and methods described above.

The elements and acts of the various embodiments described above can be combined to provide further embodiments. These and other changes can be made to the ECS in light of the above detailed description.

In general, in the following claims, the terms used should not be construed to limit the ECS to the specific embodiments disclosed in the specification and the claims, but should be construed to include all systems that operate under the claims. Accordingly, the ECS is not limited by the disclosure, but instead the scope is to be determined entirely by the claims.

While certain aspects of the ECS are presented below in certain claim forms, the inventors contemplate the various aspects of the ECS described above in any number of claim forms. Accordingly, the inventors reserve the right to add additional claims after filing the application to pursue such additional claim forms for other aspects of the ECS described above.

What is claimed is:

1. A vehicle system comprising:
an energy converter connected to a powertrain component of a powertrain of a vehicle via a connection component, the energy converter comprising converter circuitry that converts kinetic energy of the vehicle to electrical energy;
an energy storage cell coupled to the generator, the energy storage cell storing the electrical energy; and
an energy translator coupled to the energy storage cell and the energy converter, the energy translator comprising translator circuitry that converts the electrical energy of the storage cell into line voltage electricity.

2. The vehicle system of claim 1, comprising a controller coupled to the powertrain component and the energy translator.

3. The vehicle system of claim 2, wherein the controller, in response to a signal from the powertrain component, controls the converter circuitry to induce a variable load on the powertrain that converts the kinetic energy to the electrical energy.

4. The vehicle system of claim 3, wherein the variable load is charging of the energy storage cell.

5. The vehicle system of claim 3, wherein the signal from the powertrain component indicates a reduction in velocity of the vehicle.

6. The vehicle system of claim 5, wherein the controller varies the variable load to generate the reduction in the velocity of the vehicle.

7. The vehicle system of claim 3, wherein the signal from the powertrain component indicates a constant velocity of the vehicle.

8. The vehicle system of claim 7, wherein the controller varies the variable load to generate the constant velocity of the vehicle.

9. The vehicle system of claim 3, wherein the signal from the powertrain component indicates a turning of the vehicle.

10. The vehicle system of claim 9, wherein the controller varies the variable load to stabilize the vehicle in the turn.

11. The vehicle system of claim 3, wherein the signal from the powertrain component indicates absence of motion of the vehicle.

12. The vehicle system of claim 11, wherein the controller controls conversion of available output of the energy converter to the electrical energy.

13. The vehicle system of claim 1, wherein the energy converter is a generator.

14. The vehicle system of claim 1, wherein the energy converter is a plurality of generators.

15. The vehicle system of claim 1, wherein the energy converter is an alternator.

16. The vehicle system of claim 1, wherein the energy converter is a plurality of alternators.

17. The vehicle system of claim 1, wherein the powertrain component is an engine.

18. The vehicle system of claim 1, wherein the powertrain component is a transmission.

19. The vehicle system of claim 1, wherein the powertrain component is a drive shaft.

20. The vehicle system of claim 1, wherein the powertrain component is a wheel.

21. The vehicle system of claim 1, wherein the powertrain component is an axle.

22. The vehicle system of claim 1, wherein the powertrain component is a brake component.

23. The vehicle system of claim 1, wherein the powertrain component is an accelerometer.

24. The vehicle system of claim 1, wherein the powertrain component is a velocity sensor.

25. The vehicle system of claim 1, wherein the electrical energy generated by the energy converter is direct current (DC) electrical energy.

26. The vehicle system of claim 25, wherein the translator circuitry converts the direct current (DC) electrical energy to the line voltage electricity that is alternating current (AC) electrical energy.

27. The vehicle system of claim 1, wherein the translator circuitry comprises at least one of short detection circuitry, ground fault detection circuitry, and surge suppression.

28. The vehicle system of claim 1, wherein the translator circuitry comprises at least one of charge rate control circuitry, storage cell temperature control circuitry, and charge cycle depth control circuitry.

29. The vehicle system of claim 1, comprising an energy distribution access point (EDAP) connected to an electric grid, wherein the energy translator connects to the EDAP and transfers the line voltage electricity to EDAP circuitry, wherein the EDAP circuitry distributes the line voltage electricity through the electric grid.

30. The vehicle system of claim 29, wherein the translator circuitry matches at least one component of the line voltage electricity to the EDAP.

31. The vehicle system of claim 30, wherein the at least one component is voltage level.

32. The vehicle system of claim 30, wherein the at least one component is frequency.

33. The vehicle system of claim 30, wherein the at least one component is phase.

34. The vehicle system of claim 29, wherein the EDAP is connected to the electric grid using a direct connection through which the line voltage electricity that is alternating current (AC) electrical energy is downloaded directly into the electric grid.

35. The vehicle system of claim 29, wherein the EDAP is connected to the electric grid using a remote control download connection through which the line voltage electricity that is direct current (DC) electrical energy is downloaded into storage cells of the EDAP.

36. A system comprising:
an energy converter connected to a powertrain component of a vehicle via a connection component, the energy converter comprising converter circuitry that converts kinetic energy of the vehicle to electrical energy;
an energy storage cell coupled to the generator, the energy storage cell storing the electrical energy;
an energy translator coupled to the energy storage cell and the energy converter, the energy translator comprising translator circuitry that converts the electrical energy of the storage cell into line voltage electricity; and
an energy distribution access point (EDAP) connected to an electric grid, wherein the energy translator connects to the EDAP via a removable connector and transfers the line voltage electricity to EDAP circuitry, wherein the EDAP circuitry distributes the line voltage electricity through the electric grid.

37. The system of claim 36, comprising a controller coupled to the powertrain component and the energy translator, wherein the controller, in response to a signal from the powertrain component, controls the converter circuitry to induce a variable load on the powertrain that converts the kinetic energy to the electrical energy, wherein the variable load is charging of the energy storage cell.

38. The system of claim 37, wherein the signal from the powertrain component indicates a reduction in velocity of the vehicle, wherein the controller varies the variable load to generate the reduction in the velocity of the vehicle.

39. The system of claim 37, wherein the signal from the powertrain component indicates a constant velocity of the vehicle, wherein the controller varies the variable load to generate the constant velocity of the vehicle.

40. The system of claim 37, wherein the signal from the powertrain component indicates a turning of the vehicle, wherein the controller varies the variable load to stabilize the vehicle in the turn.

41. The system of claim 37, wherein the controller controls conversion of available output of the energy converter to the electrical energy.

42. The system of claim 36, wherein the energy converter is at least one of a generator, a plurality of generators, an alternator, a plurality of alternators.

43. The system of claim 36, wherein the powertrain component is at least one of an engine, a transmission, a drive shaft, a wheel, an axle, a brake component, an accelerometer, a velocity sensor.

44. The system of claim 36, wherein the electrical energy generated by the energy converter is direct current (DC) electrical energy, wherein the translator circuitry converts the direct current (DC) electrical energy to the line voltage electricity that is alternating current (AC) electrical energy.

45. The system of claim 36, wherein the translator circuitry matches a component of the line voltage electricity to the EDAP, wherein the component is at least one of voltage level, frequency, and phase.

46. The system of claim 36, wherein the EDAP is connected to the electric grid using a direct connection through which the line voltage electricity that is alternating current (AC) electrical energy is downloaded directly into the electric grid.

47. The system of claim 36, wherein the EDAP is connected to the electric grid using a remote control download connection through which the line voltage electricity that is direct current (DC) electrical energy is downloaded into storage cells of the EDAP.

48. A vehicle system comprising:
an energy converter connected to a powertrain component of a vehicle via a connection component, the energy converter comprising converter circuitry that converts kinetic energy of the vehicle to electrical energy;
an energy storage cell coupled to the generator, the energy storage cell storing the electrical energy;
an energy translator coupled to the energy storage cell and the energy converter, the energy translator comprising translator circuitry that converts the electrical energy of the storage cell into line voltage electricity; and
a controller coupled to the powertrain component and the energy translator, wherein the controller, in response to a signal from the powertrain component, controls the converter circuitry to induce a variable load on the powertrain that converts the kinetic energy to the electrical energy, wherein the variable load is charging of the energy storage cell.

49. A method for generating power, the method comprising:
receiving a signal from a powertrain component of a powertrain of a vehicle, wherein the signal represents a state of the powertrain;
inducing and controlling a variable load on the powertrain in response to the state of the powertrain;
extracting kinetic energy from the vehicle via the variable load;
converting the kinetic energy to electrical energy; and
storing the electrical energy in the vehicle.

50. The method of claim 49, comprising:
converting the stored electrical energy into line voltage electricity; and
distributing the line voltage electricity to an electric grid.

51. The method of claim 50, wherein the electrical energy is direct current (DC) electrical energy.

52. The method of claim 51, wherein the converting of the stored electrical energy into the line voltage electricity comprises converting the DC electrical energy to alternating current (AC) electrical energy.

53. The method of claim 50, comprising matching a component of the line voltage electricity to the electric grid, wherein the component comprises at least one of voltage level, frequency, and phase.

54. The method of claim 50, wherein the distributing of the line voltage electricity to the electric grid comprises distributing the line voltage using a direct connection through which the line voltage electricity that is alternating current (AC) electrical energy is downloaded directly into the electric grid.

55. The method of claim 50, wherein the distributing of the line voltage electricity to the electric grid comprises distributing the line voltage using a remote control download connection through which the line voltage electricity that is direct current (DC) electrical energy is downloaded into storage cells of the electric grid.

56. The method of claim 49, wherein the inducing and controlling the variable load comprises controlling a loading of a generator.

57. The method of claim 56, comprising controlling the state of the powertrain in response to the response to the loading of the generator, wherein the state is at least one of accelerating, decelerating, coasting, stopping, and idling.
